(19) United States
(12) Patent Application Publication
(10) Pub. No.: US 2025/0069362 A1
(43) Pub. Date: Feb. 27, 2025

(54) AUTOMATIC ITEM RECOGNITION FROM CAPTURED IMAGES DURING ASSISTED CHECKOUT

(71) Applicant: RadiusAI, Inc., Tempe, AZ (US)

(72) Inventors: Abhinav Yarlagadda, Woodinville, WA (US); Aykut Dengi, Tempe, AZ (US); Sai Krishna Bashetty, Bellevue, WA (US); Rahul Santhosh Kumar Varma, Tempe, AZ (US); Daniel King, Seattle, MA (US); Kamalesh Kalirathinam, Tempe, AZ (US); Nathan Kelly, Phoenix, AZ (US); Sri Priyanka Madduluri, Arlington, VA (US); Thomas Strich, Tempe, AZ (US)

(21) Appl. No.: 18/943,015

(22) Filed: Nov. 11, 2024

Related U.S. Application Data
(63) Continuation of application No. 18/414,276, filed on Jan. 16, 2024.
(60) Provisional application No. 63/439,113, filed on Jan. 14, 2023.
(60) Provisional application No. 63/439,149, filed on Jan. 15, 2023.
(60) Provisional application No. 63/587,874, filed on Oct. 4, 2023.

(51) Int. Cl. G06V 10/48; G06Q 20/20; G06V 10/12; G06V 10/40; G06V 10/70; G06V 10/82; G06V 10/94; G06V 20/40; G06V 20/52; G06V 40/10; G07G 1/00; G07G 1/12

(52) U.S. Cl. CPC G06V 10/48; G06Q 20/208; G06V 10/12; G06V 10/40; G06V 10/70; G06V 10/82; G06V 10/95; G06V 20/41; G06V 20/52; G06V 40/10; G07G 1/0009; G07G 1/0018; G07G 1/12; G06V 2201/10

(57) ABSTRACT

Systems and methods include extracting item parameters from images of items positioned at a POS system. The item parameters associated with each item are indicative as to an identification of each item thereby enabling the identification of each item based on the item parameters. The item parameters are analyzed to determine whether the item parameters match item parameters stored in a database. The database stores different combinations of item parameters to thereby identify each item based on each different combination of item parameters associated with each item. Each item positioned at the POS system is identified when the item parameters for each item match item parameters as stored in the database and fail to identify each item when the item parameters fail to match item parameters. The item parameters associated with the items that fail to match are streamed to the database thereby enabling the identification of each failed item.

### CROSS-REFERENCE TO RELATED APPLICATIONS

The present application is a continuation of U.S. Nonprovisional patent application Ser. No. 18/414,276, filed Jan. 16, 2024, which claims the benefit of U.S. Provisional Application No. 63/439,149, filed Jan. 15, 2023, and also claims the benefit of U.S. Provisional Application No. 63/439,113, filed Jan. 14, 2023, and also claims the benefit of U.S. Provisional Application No. 63/587,874, filed on Oct. 4, 2023 both of which are incorporated herein by reference in their entirety.

### BACKGROUND

Retailers often incorporate self-checkout systems at the Point of Sale (POS) in order to decrease the wait time of customers to have their selected items scanned and purchased at the POS. Self-checkout systems also reduce the footprint required for the checkout systems as assisted checkout systems require less footprint than traditional checkout systems that are staffed with a cashier. Self-checkout systems also reduce the quantity of cashiers required to staff the self-checkout systems as one or two cashiers may be able to manage several self-checkout systems rather than having a cashier positioned at every checkout system.

Self-checkout systems require the customer to scan one selected item for purchase at a time once positioned at the POS for items which have a Universal Product Code (UPC) which is scanned by the customer at the POS thereby identifying the item based on the scanned UPC. Selected items for purchase that do not have a UPC require the customer to then navigate through the self-checkout system to type in the name of the item without a UPC and then select the item in that manner. Errors often happen in which an item was not properly scanned and/or properly identified causing the self-checkout system to pause and require intervention by the cashier. Conventionally, self-checkout systems require intense interaction by the customer to essentially execute the checkout of the items by themselves. Self-checkout systems also increase the wait time for customers to checkout due to the pausing of the self-checkout systems and requiring the intervention of the cashier before continuing with the checkout process.

### BRIEF SUMMARY

Embodiments of the present disclosure relate to providing a point of sale (POS) system that automatically identifies items positioned at the POS for purchase based on images captured of the items by cameras positioned at the POS as well as cameras positioned throughout the retail location. A system may be implemented to automatically identify a plurality of items positioned at a POS system based on a plurality of item parameters associated with each item as provided by a plurality of images captured by a plurality of cameras positioned at the POS system. The system includes at least one processor and a memory coupled with the at least one processor. The memory includes instructions that when executed by the at least one processor cause the processor extract the plurality of item parameters associated with each item positioned at the POS system from the plurality of images captured of each item by the plurality of cameras positioned at the POS system. The item parameters associated with each item when combined are indicative as to an identification of each corresponding item thereby enabling the identification of each corresponding item. The processor is configured to analyze the item parameters associated with each item positioned at the POS system to determine whether the item parameters associated with each item when combined matches a corresponding combination of the item parameters stored in an item parameter identification database. The item parameter identification database stores different combinations of item parameters with each different combination of item parameters associated with a corresponding item thereby identifying each corresponding item based on each different combination of item parameters associated with each corresponding item. The processor is configured to identify each corresponding item positioned at the POS system when the item parameters associated with each item when combined match a corresponding combination of item parameters as stored in the item parameter identification database and fail to identify each corresponding item when the item parameters associated with each item when combined fail to match a corresponding combination of item parameters. The processor is configured to stream the item parameters with each item positioned at the POS system that fail to match to the item parameter identification database thereby enabling the identification of each failed item when the combination of item parameters of each failed item are subsequently identified when subsequently positioned at the POS system after the failed match.

In an embodiment, a method automatically identifies a plurality of items at a Point of Sale (POS) system based on a plurality of item parameters associated with each item as provided by a plurality of images captured by a plurality of cameras positioned at the POS system. The plurality of item parameters associated with each item positioned at the POS system may be extracted from the plurality of images captured of each item by the plurality of cameras positioned at the POS system. The item parameters associated with each item when combined are indicative as to an identification of each corresponding item thereby enabling the identification of each corresponding item. The item parameters associated with each item positioned at the POS system may be analyzed to determine whether the item parameters associated with each item when combined matches a corresponding combination of the item parameters stored in an item parameter identification database. The item parameter identification database stores different combinations of item parameters with each different combination of item parameters associated with a corresponding item thereby identifying each corresponding item based on each different combination of item parameters associated with each corresponding item. Each corresponding item positioned at the POS system may be identified when the item parameters associated with each item when combined match a corresponding combination of item parameters as stored in the item parameter identification database and fail to identify each corresponding item when the item parameters associated with each item when combined fail to match a corresponding combination of item parameters. The item parameters associated with each item positioned at the POS system that fail to match to the item parameter identification database may be streamed thereby enabling the identification of each failed item when the combination of item parameters of each failed item are subsequently identified when subsequently positioned at the POS system after the failed match.

Further embodiments, features, and advantages, as well as the structure and operation of the various embodiments, are described in detail below with reference to the accompanying drawings.

### BRIEF DESCRIPTION OF THE DRAWINGS

Embodiments are described with reference to the accompanying drawings. In the drawings, like reference numbers may indicate identical or functionally similar elements.

FIG. 1 depicts an illustration of an item identification configuration;

FIG. 2 shows an illustration of a perspective view of an example item identification configuration;

FIG. 3 depicts an illustration of an example system of item identification;

FIG. 4 depicts an illustration of a flow diagram of an example method for item identification;

FIG. 5 depicts an illustration of a flow diagram of an example method for item identification;

FIG. 6A depicts an illustration of an example machine learning recognition of items positioned on a Point of Sale (POS) system; and

FIGS. 6B-6C depict illustrations of flow diagrams illustrating additional examples of machine learning recognition of items positioned at the POS system.

### DETAILED DESCRIPTION

Embodiments of the disclosure generally relate to providing a system for assisted checkout in which items positioned at the Point of Sale (POS) system are automatically identified thereby eliminating the need for the customer and/or cashier to scan and/or identify items that cannot be scanned manually. In an example embodiment, the customer approaches the POS system and positions the items which the customer requests to purchase at the POS system. Cameras positioned at the POS system capture images of each item and then an item identification computing device may then extract item parameters associated with each item from the images captured of each item by the cameras. The item parameters associated with each item are specific to each item and when combined may identify the item thereby enabling identification of each corresponding item. Item identification computing device may then automatically identify each item positioned at the POS system based on the item parameters associated with each item as extracted from the images captured of each item. In doing so, the customer simply has to position the items at the POS system and is not required to scan and/or identify items that cannot be scanned. The cashier simply needs to intervene when there is an issue when an item is not identified by item computing device.

However, in an embodiment, item identification computing device may continuously learn via a neural network in identifying each of the numerous items that may be positioned at the POS system for purchase by the customer. Each time that an item that is positioned at the POS system for purchase that item identification computing device does not identify, such item parameters associated with the unknown item may be automatically extracted from the images captured of the unknown by item identification computing device and provided to a neural network. The neural network may then continuously learn based on the item parameters of the unknown item thereby enabling item identification computing device to correctly identify the previous unknown item in subsequent transactions. The unknown item may be presented at numerous different locations in which item identification computing device automatically extracts the item parameters of the unknown item as presented at numerous different locations and provided to the neural network such that the neural network may continuously learn when the unknown item is presented at any retail location thereby significantly decreasing the duration of time required for item identification computing device to correctly identify the previously unknown item.

In the Detailed Description herein, references to “one embodiment”, an “embodiment”, and “example embodiment”, etc., indicate that the embodiment described may include a particular feature, structure, or characteristic, by every embodiment may not necessarily include the particular feature, structure, or characteristic. Moreover, such phrases are not necessarily referring to the same embodiment. Further, when a particular feature, structure, or characteristic may be described in connection with an embodiment, it may be submitted that it may be within the knowledge of one skilled in art to affect such feature, structure, or characteristic in connection with other embodiments whether or not explicitly described.

The following Detailed Description refers to the accompanying drawings that illustrate exemplary embodiments. Other embodiments are possible, and modifications can be made to the embodiments within the spirit and scope of this description. Those skilled in the art with access to the teachings provided herein will recognize additional modifications, applications, and embodiments within the scope thereof and additional fields in which embodiments would be of significant utility. Therefore, the Detailed Description is not meant to limit the embodiments described below.

### System Overview

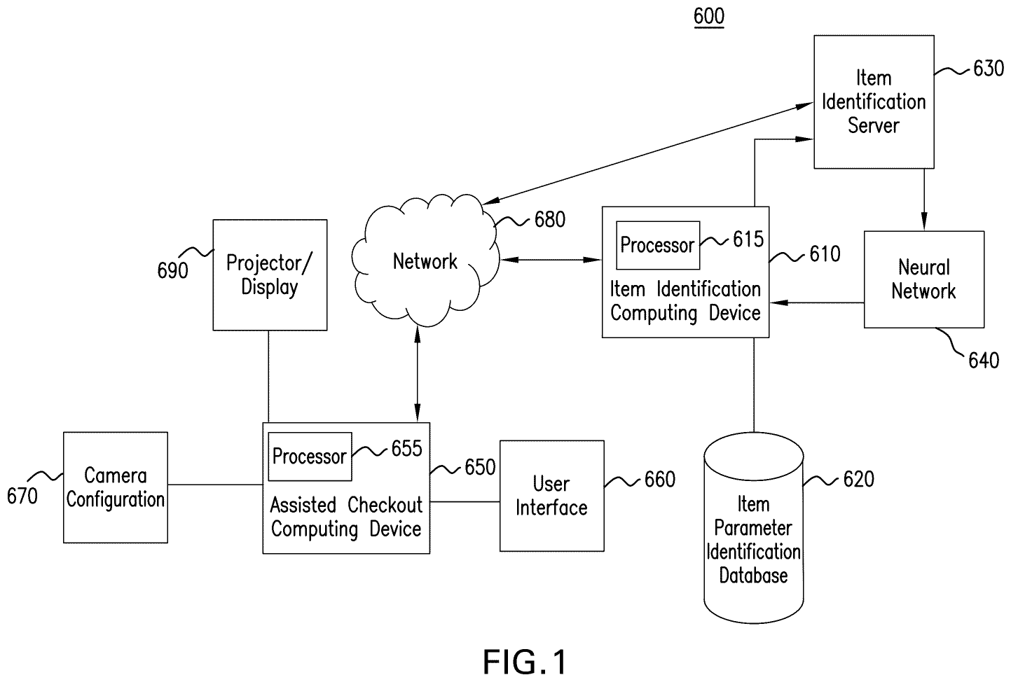

As shown in FIG. 1, an item identification configuration 600 includes an item identification computing device 610, an assisted checkout computing device 650, a camera configuration 670, a user interface 660, a projector/display 690, an item identification server 630, a neural network 640, an item parameter identification database 620, and a network 680. Image identification computing device 610 includes a processor 615. Assisted checkout computing device 650 includes a processor 655.

The checkout process, during which items intended to be purchased by a customer are identified, and prices tallied, by an assigned cashier. The term Point of Sale (POS) is the area within a retail location at which the checkout process occurs. Conventionally, the checkout process presents the greatest temporal and spatial bottleneck to profitable retail activity. Customers spend time spent waiting for checkout to commence in a checkout line staffed by a cashier where the cashier executes the checkout process and/or in a line waiting to engage a self-checkout station and completing checkout where the cashier scans the items individually and/or the customer scans the items individually in a self-checkout station.

As a result, the checkout process reduces the turnover of customers completing journeys within the retail location in which the journey of the customer is initiated when the customer arrives at the retail location and continues as the customer proceeds through the retail location, and concludes when the customer leaves the retail location. The reduction in turnover in the customers completing journeys results in a reduction of sales by the retailer as customers are simply proceeding through the retail location less and thereby reducing the opportunity for the customers to purchase items. The conventional checkout process also impedes the flow of customer traffic within the retail location and also serves as a point of customer dissatisfaction in the shopping experience, as well as posing a draining and repetitive task for cashiers. Customers also appreciate and expect human interaction during checkout, and conventional self-checkout systems are themselves a point of aggravation in the customer experience.

Item identification configuration 600 may provide a defined checkout plane upon which items are placed at the POS system for recognition by item identification computing device 610. Assisted checkout computing device 650 may then automatically list items presented at the POS system for purchase by their customer and tally the prices of the items automatically identified by item identification computing device 610. In doing so, the human labor associated with scanning the items one-by-one and/or identifying the items one-by-one may be significantly reduced for the cashiers as well as the customers. Item identification configuration 600 may implement artificial intelligence to recognize the items placed on the checkout plane at the POS system at once, even when such items may be bunched together to occlude views of portions of some of the items, and of continually improving the recognition accuracy of item identification computing device 610 through machine learning.

A customer may enter a retail location of a retailer and browse the retail location for items in which the customer requests to purchase from the retailer. The retailer may be an entity that is selling items and/or services for purchase. The retail location may be brick and mortar location and/or an on-site location that the customer may physically enter and/or exit the retail location when completing the journey of the customer in order to purchase the items and/or services located at the retail location. As noted above, the retail location also includes a POS system in which the customer may engage to ultimately purchase the items and/or services from the retail location. The customer may then approach the POS system to purchase the items in which the customer requests to purchase.

In doing so, the customer may present the items at the POS system in which the POS system includes a camera configuration 670. Camera configuration 670 may include a plurality of cameras positioned in proximity of the checkout plane such that each camera included in camera configuration 670 may capture different perspectives of the items positioned in the checkout plane by the customer. For example, the checkout plane may be a square shape and camera configuration 670 may then include four cameras in which each camera is positioned in one of the corresponding corners of the square-shaped checkout plane. In doing so, each of the four cameras may capture a different perspective of the square-shaped checkout plane thereby also capturing a different perspective of the items positioned on the checkout plane for purchase by the customer. In another example, camera configuration 670 may include an additional camera positioned above the checkout plane and/or an additional camera positioned below the checkout plane. Camera configuration 670 may include any quantity of cameras positioned in any type of configuration to capture different perspectives of the items positioned in the checkout plane for purchase that will be apparent to those skilled in the relevant art(s) without departing from the spirit and scope of the invention.

The POS system may also include assisted checkout computing device 650. Assisted checkout computing device 650 may be the computing device positioned at the POS system that enables the customer and/or cashier to engage the POS system. Assisted checkout computing device 650 may include user interface 660 such that user interface displays each of the items automatically identified as positioned at the POS system for purchase as well as the price of each automatically identified item as well as the total cost of the automatically identified item. Assisted checkout computing device 650 may also display via user interface any items that were not automatically identified and enable the cashier and/or customer to scan the unidentified item. Assisted checkout computing device 650 may be positioned at the corresponding POS system at the retail location.

One or more assisted checkout computing devices 650 may engage item identification computing device 610 as discussed in detail below in order to interface with of each of the customers and/or cashiers in real-time via user interface 660 with regard to their request for purchase of the item. Examples of assisted checkout computing device 650 may include a mobile telephone, a smartphone, a workstation, a portable computing device, other computing devices such as a laptop, or a desktop computer, cluster of computers, set-top box, and/or any other suitable electronic device that will be apparent to those skilled in the relevant art(s) without departing from the spirit and scope of the disclosure.

In an embodiment, multiple modules may be implemented on the same computing device. Such a computing device may include software, firmware, hardware or a combination thereof. Software may include one or more applications on an operating system. Hardware can include, but is not limited to, a processor, a memory, and/or graphical user interface display.

Item identification computing device 610 may be a device that is identifying items provided to assisted checkout computing device 650 for purchase based on images captured by camera configuration 670. Examples of assisted checkout computing device 650 may include a mobile telephone, a smartphone, a workstation, a portable computing device, other computing devices such as a laptop, or a desktop computer, cluster of computers, set-top box, and/or any other suitable electronic device that will be apparent to those skilled in the relevant art(s) without departing from the spirit and scope of the disclosure.

In an embodiment, multiple modules may be implemented on the same computing device. Such a computing device may include software, firmware, hardware or a combination thereof. Software may include one or more applications on an operating system. Hardware can include, but is not limited to, a processor, a memory, and/or graphical user interface display.

Item identification computing device 610 may be positioned at the retail location, may be positioned at each POS system, may be integrated with each assisted checkout computing device 650 at each POS system, may be positioned remote from the retail location and/or assisted checkout computing device 650 and/or any other combination and/or configuration to automatically identify each item positioned at the POS system and then the identification displayed by assisted checkout computing device 650 that will be apparent to those skilled in the relevant art(s) without departing from the spirit and scope of the invention.

Rather than have a cashier then proceed with scanning the items in which the customer requests to purchase and/or have the customer scan such items as positioned at the POS system, item identification computing device 610 may automatically identify the items in which the customer requests to purchase based on the images captured of the items by camera configuration 670. Assisted checkout computing device 650 may then automatically display the items in which the customer requests to purchase via user interface 660 based on the automatic identification of the items by item identification computing device 610. The customer may then verify that the displayed items are indeed the items that the customer requests to purchase and proceed with the purchase without intervention from the cashier.

As a result, the retailer may request that numerous items in which the retailer has for purchase in the numerous retail locations of the retailer be automatically identified by item identification computing device 610 as the customer presents any of the numerous items at the POS system to purchase. The retailer may have numerous items that differ significantly based on different item parameters. Each item includes a plurality of item parameters that when combined are indicative as to an identification of each corresponding item thereby enabling identification of each item by item identification computing device 610 based on the item parameters of each corresponding item. The item parameters associated with each item may be specific to the corresponding item in which each time the item is positioned at the POS system, the images captured of the corresponding item by camera configuration 670 depict similar item parameters thereby enabling item identification computing device 650 to identify the item each time the item is positioned at the POS system. The item parameters associated with each item may also be repetitive in which substantially similar items may continue to have the same item parameters such that the item parameters provide insight to item identification computing device 610 as to the item that has been selected for purchase by the customer. In doing so, the item parameters may be repetitively incorporated into substantially similar items such that the item parameters may continuously be associated with the substantially similar items thereby enabling the item to be identified based on the item parameters of the substantially similar items.

For example, a twelve ounce can of Coke includes item parameters specific to the twelve ounce can of Coke such as the shape of the twelve ounce can of Coke, the size of the twelve ounce can of Coke, the lettering on the twelve ounce can of Coke, the color of the twelve ounce can of Coke and so on. Such item parameters are specific to the twelve ounce can of Coke and differentiate the twelve ounce can of Coke from other twelve ounce cans of soda pop thereby enabling item identification computing device 610 to automatically identify the twelve ounce can of Coke based on such item parameters specific to the twelve ounce can of Coke. Additionally, each twelve once can of Coke as canned by Coca-Cola and distributed to the retail locations include substantially similar and/or the same item parameters as every other twelve ounce can of Coke canned by Coca-Cola and then distributed to the retail locations. In doing so, each time a twelve ounce can of Coke is positioned at any POS system at any retail location, item identification computing device 610 may automatically identify the twelve ounce can of Coke based on the repetitive item parameters specific to every twelve ounce can of Coke.

Item parameters may include but not limited to such as brand name and brand features of the item, ingredients of the item, weight of the item, metrology of the item such as height, width, length, and shape of the item, UPC of the item, SKU of the item, color of the item, and/or any other item parameter associated with the item that may identify the item that will be apparent to those skilled in the relevant art(s) without departing from the spirit and scope of the invention.

In doing so, each item in which the retailer requests to be automatically identified by and displayed by assisted checkout computing device 610 may be presented to item identification computing device 610 such that item identification computing device 610 may be trained to identify each item in offline training. The training of item identification computing device 610 in offline training occurs when the item is provided to item identification computing device 610 for training offline from when the item is presented to assisted checkout computing device 650 such that offline training occurs independent from actual purchase of the item as presented to assisted checkout computing device 650. Each item may be presented to item identification computing device 610 such that item identification computing device 610 may scan each item to incorporate the item parameters of each item as well as associate the item parameters with a UPC and/or SKU associated with the item. Item identification computing device 610 may then associate the item parameters of the item to the UPC and/or SKU of the item and store such item parameters that are specific to the item and correlate to the UPC and/or SKU of the item in the item parameter identification database 620. For purpose of simplicity, UPC may be used throughout the remaining specification but such reference may include but is not limited to UPCs, IANs, EANs, SKUs, and/or any other scan related identification protocol that will be apparent from those skilled in the relevant art(s) without departing from the spirit and scope of the present disclosure.

Each iteration that the item is scanned by item identification computing device 610, such item parameters of the item of each scan may further be stored in item parameter identification database 620. The item parameters captured for each iteration of scanning the item may then be provided to item identification server 630 and incorporated into neural network 640 such that neural network 640 may continue to learn as to the item parameters associated with the item for each iteration thereby increasing the accuracy of item identification computing device 610 correctly identifying the item. In doing so, assisted checkout computing device 650 also increases the accuracy in displaying to the customer via user interface 660 the correct identification of the item in which the customer presents to the POS system to request to purchase thereby streamlining the purchase process for the customer and the retailer.

However, such training of item identification computing device 610 occurs in offline training in which the retailer presents a list of the items that the retailer requests to be automatically identified in which the list includes the item and corresponding UPC. Each item on the list is then provided to item identification computing device 610 and each item is continuously scanned by identification computing device 610 in order for a sufficient quantity of iterations to be achieved until item identification computing device 610 may accurately identify the item. Such offline iterations is time consuming and costly as assisted checkout computing device 650 may fail in accurately displaying the identification of the item to the customer via user interface 660 in which the customer requests to purchase until item identification computing device 610 has obtained the sufficient of quantity of iterations to correctly identify the item via neural network 640.

Further, the retailer may continuously be adding new items to the numerous retail locations of the retailer in which such new items are available to purchase by the customer. Item identification computing device 610 may have not had the opportunity to be trained on the continuously added new items in offline training. Often times, the retailer has numerous retail locations and the retailer may not have control over their own supply chain. In doing so, the retailer may not know when items will be arriving each of the numerous retail locations as well as when the items will be ultimately purchased and discontinued at each of the numerous retail locations. As a result, item identification computing device 610 may not have the opportunity to execute offline learning of such numerous items at each of the numerous retail locations. In doing so, the new items may be continuously presented for purchase to assisted checkout computing device 650 but assisted checkout computing device 650 may fail to correctly display identification of the item to the customer via user interface 660 due to item identification computing device 610 not having the opportunity to receive the quantity of iterations in offline training to identify the new items.

However, each time that the customer presents an item to assisted checkout computing device 650 in which item identification computing device 610 may not have had sufficient iterations to train in offline manner to identify the item may actually be an iteration opportunity for item identification computing device 610 to train in identifying the item in online training. Item identification computing device 610 may train in identifying the item in online training when the customer presents the item to assisted checkout computing device 650 for purchase such that camera configuration 670 captures images of the item parameters associated with the item thereby enabling item identification computing device 610 to capture an iteration of training at the POS system of the item rather than doing so offline.

The retailer may experience numerous transactions in which the customer requests to purchase the item in which item identification computing device 610 has not had the opportunity to sufficiently train in offline training. Such numerous transactions provide the opportunity for item identification computing device 610 to train in online training to further streamline the training process in identifying the items. Further, the training of item identification computing device 610 with iterations provided by the customer requesting to purchase the item at the POS system further bolsters the accuracy in the identification of the item by item identification computing device 610 even after item identification computing device has been sufficiently trained with iterations in offline training. Thus, the time in which to train item identification computing device 610 to accurately identify the item is decreased as well as the overhead to do so by adding the online training to supplement the offline training of item identification computing device 610.

As a result, the automatic identification of the items positioned at assisted checkout computing device 650 at the POS by item identification computing device 610 may enable the retailer to have the staff working at each retail location to execute tasks that have more value than simply scanning items. For example, the staff working at each retail location may then greet customers, stock shelves, perform office administration, and/or any other task that provides more value to the retailer as compared to simply scanning items. In doing so, the retailer may reduce the quantity of staff working at each retail location during each shift while also gaining move value from such staff working at each retail location during each shift due to the increase in value of the tasks that each staff member may now execute without having to scan items and/or manage a conventional self-checkout system that fails to automatically identify the items positioned at such conventional POS systems. The automatic identification of the items positioned at assisted checkout computing device 650 at the POS may also enable the retailer to execute a fully autonomous self-checkout system in addition to also reducing staff. Regardless, the automatic identification of the items positioned at assisted checkout computing device 650 at the POS provides the retailer with increased flexibility in staffing each retail location during each shift.

Item identification computing device 610 may be a device that is identifying items provided to assisted checkout computing device 650 for purchase based on images captured by camera configuration 670. One or more assisted checkout computing devices 650 may engage item identification computing device 610 in order to interface with of each of the customers and/or cashiers in real-time via user interface 660 with regard to their request for purchase of the item. User interface 660 may include any type of display device including but not limited to a touch screen display, a liquid crystal display (LCD) screen, a light emitting diode (LED) display and/or any other type of display device that includes a display that will be apparent from those skilled in the relevant art(s) without departing from the spirit and scope of the present disclosure.

### Continuous Self-Learning

Item identification computing device 610 may extract the plurality of item parameters associated with each item positioned at the POS system from the plurality of images captured of each item by the plurality of cameras 670 positioned at the POS system. The item parameters associated with each item when combined are indicative as to an identification of each corresponding item thereby enabling the identification of each corresponding item. As discussed above, camera configuration 670 as positioned at the POS system may capture images of the items positioned at the POS system for purchase by the customer. Such item parameters of each item when combined provide an indication as to the identity of the item such that item identification computing device 610 may automatically identify each item based on the combination of item parameters for each item as captured by the images of each item by camera configuration 670.

Item identification computing device 610 may then analyze the item parameters associated with each item positioned at the POS system to determine whether the item parameters associated with each item when combined matches a corresponding combination of the item parameters stored in an item parameter identification database 620. Item parameter identification database 620 stores different combinations of item parameters with each different combination of item parameters associated with a corresponding item thereby identifying each corresponding item based on each different combination of item parameters associated with each corresponding item. As discussed above, as item identification computing device 610 trains, item parameters for each item that are collected and then stored in item parameter identification database 620 as associated with each item. For example, the item parameters of the twelve ounce can of Coke are stored in item parameter identification database 620 and are associated with the twelve ounce can of Coke. Item identification computing device 610 may then extract the item parameters of the twelve ounce can of Coke from the images captured of the twelve ounce can of Coke by camera configuration 670 when positioned at the POS system and determine whether such extracted item parameters when combined match a combination of item parameters stored in item parameter identification database 620.

Item identification computing device 610 may then identify each corresponding item positioned at the POS system when the item parameters associated with each item when combined match a corresponding combination of item parameters as stored in item parameter identification database 620 and fail to identify each corresponding item when the item parameters associated with each item when combined fail to match a corresponding combination of item parameters. As discussed above, item identification computing device 610 may extract the item parameters from the images captured of the item positioned at the POS system and attempt to match the combination of item parameters with a combination of item parameters stored in item parameter identification database 620.

Item identification computing device 610 may then identify the item positioned at the POS system when the combination of item parameters matches a combination of item parameters stored in item parameter identification database 620. For example, item identification computing device 610 may automatically identify the twelve ounce can of Coke when the combination of item parameters extracted from the images captured of the twelve ounce can of Coke match the combination of item parameters stored in item parameter identification database 620 that are associated with the twelve ounce can of Coke. Thus, item identification computing device 610 thereby automatically identifies the twelve ounce can of Coke positioned at the POS system and assisted checkout computing device 650 displays the identification of the twelve ounce can of Coke to the customer.

However, item identification computing device 610 may fail to identify an item positioned at the POS system when item identification computing device 610 fails to match the combination of item parameters as extracted from the images captured of the item with a combination of item parameters as stored in item parameter identification database 620. Item identification computing device 610 may fail to match the combination of item parameters associated with the item positioned at the POS system to a combination of item parameters stored in item parameter identification database 620 when item identification computing device 610 has yet to execute the quantity of iterations to adequately train to identify the item. As a result, the combination of item parameters of the unknown item have yet to be created and adequately associated with the unknown item in item parameter identification database 620 thereby resulting in the unknown item being unknown to item identification computing device 610.

Item identification computing device 610 may then stream the item parameters associated with each item positioned at the POS system that fail to match to item parameter identification database 620 thereby enabling the identification of each failed item when the combination of item parameters of each failed item are subsequently identified when subsequently positioned at the POS system after the failed match. Item identification computing device 610 may stream the item parameters associated with the unknown item such that item identification computing device 610 may then be trained to automatically identify the unknown item when the unknown item is subsequently positioned at the POS system.

Each time that the unknown item is positioned at the POS system and item identification computing device 610 then automatically streams the item parameters of the unknown item results in an iteration of training for item identification computing device 610. After a series of iterations in which the unknown item is positioned at the POS system and such item parameters are streamed by item identification computing device 610 for training, such item parameters are then stored in item parameter identification database 620 and associated with the unknown item. As a result, each time the unknown item is subsequently positioned at the POS system, item identification computing device 610 may match the combination of item parameters to the combination of item parameters associated with the item in item identification computing device 610 thereby enabling item identification computing device 610 to identify the previously unknown item.

Item identification computing device 610 may automatically extract the item parameters associated with each item positioned at the POS system from the images captured of each item that failed to be identified as POS data. The POS data depicts the item parameters captured at the POS system and identified as failing to match a corresponding combination of item parameters stored in item parameter identification database 620. Item identification computing device 610 may automatically stream the POS data and each corresponding image captured of each item positioned at the POS system that failed to match a corresponding combination of item parameters stored in item parameter identification database 620 to an item identification server 630.

For example, the twelve ounce can of Coke may be positioned at the POS system by the customer for purchase and item identification computing device 610 may automatically identify the twelve ounce can of Coke based on the combination of item parameters associated with the twelve ounce can of Coke as discussed above. However, a twelve ounce can of holiday Coke may be positioned at the POS system. The retailer may have not had the opportunity to conduct offline training of item identification computing device 610 with regard to automatically identifying the twelve ounce can of holiday Coke as the retailer may have had no notification as to when the twelve ounce cans of holiday Cokes were scheduled to arrive at the retail location and be stocked on the shelves of the retail location. The twelve ounce can of holiday Coke differs in color and design from the standard twelve ounce can of holiday Coke. Thus, in such an example, item identification computing device 610 automatically extracts the item parameters associated with the twelve ounce can of holiday Coke from the images captured of the twelve ounce can of holiday Coke as POS data and streams such POS data to item identification server 630 as failing to match item parameters stored in item parameter identification database 620.

Item identification computing device 610 may automatically receive updated streamed POS data associated with each image captured of each item that failed to be identified as trained on a neural network 640 based on machine learning as the neural network 640 continuously updates the streamed POS data based on past POS data as captured from past images captured of each item previously positioned at the POS system that failed to be identified as streamed from item identification server 630. As discussed above, item identification computing device 610 may automatically stream the POS data that identifies the item parameters associated with the unknown item as extracted from the images of the unknown item to item identification server 630 each time item identification computing device 610 encounters the unknown item when positioned at the POS system. Item identification server 630 may then incorporate a neural network 640 such that the POS data of the unknown item may be trained on by neural network 640 based on machine learning. Each time the POS data of the unknown item is streamed by item identification computing device 610 to item identification server 640, such streamed POS data is updated by neural network 640 based on the past POS data trained on by neural network 640 of past instances of when item identification computing device 610 encountered the unknown item when positioned at the POS system.

For example, each time that the twelve ounce can of holiday Coke is positioned at the POS system and item identification computing device 610 fails to identify the twelve ounce can of holiday Coke, the item parameters of the twelve ounce can of holiday Coke including the color and design may be streamed to item identification server 630 such that neural network 640 may train such POS data based on machine learning to be associated with the twelve ounce can of holiday Coke. Neural network 640 incorporates the POS data of each time that item identification computing device 610 fails to identify the twelve ounce can of holiday Coke with the past POS data of each previous time that item identification computing device 610 failed to identify the twelve ounce can of holiday Coke.

Item identification computing device 610 may analyze the updated streamed POS data as provided by neural network 640 to determine a plurality of identified item parameters associated with each item currently positioned at the POS system that failed to be identified when previously positioned at the POS system. The identified item parameters associated with each item are indicative to an identity of each item currently positioned at the POS system when each item previously positioned at the POS system failed to match a corresponding combination of item parameters as stored in item parameter identification database 620. Item identification computing device 610 may automatically identify each corresponding item currently positioned at the POS system when the identified item parameters associated with each item are provided by neural network 640 when combined match the corresponding combination of item parameters associated with each item as stored in item parameter identification database 620.

As discussed above, each time the POS data of the unknown item is streamed by item identification computing device 610 to item identification server 630, such streamed POS data is updated by neural network 640 based on past POS data trained on by neural network 640 of past instances when item identification computing device 610 encountered the unknown item. After a sufficient quantity of iterations in which item identification computing device 610 encountered the unknown item positioned at the POS system and streamed the POS data of the unknown item to neural network 640 such that the POS data of each iteration of the unknown item is trained on by neural network 640, neural network 640 provides the updated streamed POS data that is sufficiently trained such that item identification computing device 610 may then automatically identify the previously unknown item. In doing so, the identified item parameters included in the updated streamed POS data as provided by neural network 640 to item identification computing device 610 enables item identification computing device 610 to match the combination of such identified item parameters to item parameters associated with the previously unknown item in item parameter identification database 620 thereby enabling item identification computing device 610 to identify the previously unknown item.

For example, after a sufficient quantity of iterations in which the twelve ounce can of holiday Coke is positioned at the POS system and item identification computing devices 610 fails to identify the twelve ounce can of holiday Coke, the item parameters of the twelve ounce can of Coke including the color and design may be sufficiently trained on by neural network 640. In doing so, neural network 640 may then provide the identified item parameters of the color and design of the twelve ounce can of holiday Coke to item identification computing device 610 such that item identification computing device 610 may identify the color and design of the twelve ounce can of holiday Coke as being the twelve ounce can of holiday Coke despite the twelve ounce can of holiday Coke having different color and design from a standard twelve ounce can of Coke.

Item identification computing device 610 may automatically map the images captured of each item positioned at the POS system that failed to be identified to a corresponding POS record. The POS record is generated by assisted checkout computing device 650 of the POS system for each item that is positioned at the POS system. The POS record provides data associated with the unknown item that is positioned at the POS system. Such data included in the POS record is data specific to the transaction in which the unknown item is positioned at the POS system for purchase. Each time that the unknown item is positioned at the POS system for purchase and fails to be identified by item identification computing device 610, a new POS record is generated for each transaction in which each POS record for each transaction is mapped to the images captured of the unknown item during each transaction. Item identification computing device 610 may automatically extract the POS data as generated from the item parameters extracted from each of the images captured of each item positioned at the POS system from the images captured of each item that failed to be identified. Item identification computing device 610 may automatically generate a data set for each item that failed to be identified that matches each corresponding POS record to the corresponding images of each item when positioned at the POS system thereby generating the corresponding POS record.

The POS data extracted from each of the images captured of each item that failed to be identified is incorporated into the data set of each item that failed to be identified based on the mapping of the images of each item that failed to be identified to the corresponding POS record. Item identification computing device 610 may automatically stream the POS data and each corresponding image captured of each item positioned at the POS system that failed to be identified to item identification server 630 as included in each data set associated with each item that failed to be identified to be trained on neural network 640 based on machine learning as the neural network 640 continuously updates the streamed POS data as included in each data set based on past POS data included in the data set as captured from past images captured of each item previously positioned at the POS system that failed to be identified.

Each time that the unknown item is positioned at the POS system and item identification computing device 610 fails to identify the unknown item, item identification computing device 610 automatically generates a data set for the specific transaction in which the unknown item fails to be identified. In doing so, item identification computing device 610 automatically maps the images captured of the unknown item as captured at the POS system to the POS record as well as mapping the POS data from the item parameters extracted from the images captured of the unknown item. The mapping of the images and the POS data to the POS record that is specific to the transaction in which item identification computing device 610 fails to identify the unknown item enables several data sets associated with the unknown item to be generated. Each transaction in which item identification computing device 610 fails to identify the unknown item results in the automatic generation of data set for that specific transaction.

The automatic generation of data sets then enables continuous training in that item identification computing device 610 may then provide each of the several data sets associated with the unknown item to neural network 640 in which neural network 640 may then train the POS data associated with each of the data sets for the unknown item to identify the unknown item. Each of the data sets that are generated from each transaction in which item identification computing device 610 fails to identify the item may have POS data that is similar as the POS data generated from the item parameters extracted from the images of the unknown item during each transaction may be similar as such images are captured of the same unknown item. Thus, the automatic generation of the data sets may decrease the duration of time required for the neural network 640 to train on the POS data included in each of the data sets to ultimately identify the unknown item as the neural network may associate the similar POS data included in each of the data sets and associate the similar POS data to the unknown item with increased efficiency.

In doing so, the automatic generation of data sets may enable item identification computing device 610 to identify the unknown item despite the unknown item being positioned with other unknown items. For example, a first retail location may have a customer position a holiday Coke with a holiday Dr. Pepper at a POS system located in the first retail location. Item identification computing device 610 may then automatically generate a data set for the unknown holiday Coke and a data set the unknown holiday Dr. Pepper in which the images of the unknown holiday Coke and the images of the unknown holiday Dr. Pepper are mapped to each respective data set as well as the POS record for the transaction of each at the first retail location. At a second retail location, a customer may position an unknown holiday Coke with a known Monster Energy Drink.

Item identification computing device 610 may then automatically generate a data set for the unknown holiday Coke in which the images of the unknown holiday Coke are mapped to the data set as well as the POS record for the transaction of the unknown holiday Coke at the second retail location. At a third retail location, a customer may position an unknown holiday Coke with an unknown holiday Dr. Pepper at a POS system located in the third retail location. Item identification computing device 610 may then automatically generate a data set for the unknown holiday Coke and a data set for the unknown holiday Dr. Pepper in which the images of the unknown holiday Coke and the images of the unknown holiday Dr. Pepper are mapped to each respective data set as well as the POS record for the transaction of each at the third retail location.

Item identification computing device 610 may then determine based on the comparison POS data included in each of the data sets for the unknown holiday Coke and the unknown Dr. Pepper at each of the three retail locations that the POS data in each of the three retail locations map to item parameters that are specific to the holiday Coke and the holiday Dr. Pepper thereby enabling the identification of the holiday Coke and the holiday Dr. Pepper. The data sets may then be streamed by item identification computing device to item identification server 620 such that neural network 640 may train on the POS data included in each of the data sets associated with the holiday Coke and the holiday Dr. Pepper to enable item identification computing device 610 to automatically identify the holiday Coke and the holiday Dr. Pepper in subsequent transactions.

Item identification computing device 610 may automatically extract a plurality of features associated with each item positioned at the POS system from the images captured of each item that failed to be identified. Item identification system 610 may automatically map the features associated with each item positioned at the POS system that failed to be identified to a corresponding POS record. Item identification computing device 610 may generate a corresponding feature vector that includes the features associated with each corresponding item positioned at the POS system that failed to be identified to map each corresponding feature vector to each corresponding data set for each item that failed to be identified based on the POS record for each item that failed to be identified. Item identification computing device 610 may automatically stream each corresponding feature vector and each corresponding image of each item positioned at the POS system that failed to be identified to item identification server 630 as included in each data set associated with each item that failed to be identified to be trained on neural network 640 based on machine learning updates the streamed feature vectors as included in each data set to associate the features of each corresponding item to identify each item that failed to be identified based on the features included in each corresponding feature vector for each item.

As discussed above, item identification computing device 610 may attempt to identify the item that is presented to assisted checkout computing device 650 for purchase by the customer based on item parameters associated with the item as captured by camera configuration 670. Item identification computing device 610 may attempt to identify the item based on item parameters that include visual features of the item. Visual features of the item are features that are specific to the item and are visible and when associated with the item identify the item. In doing so, item identification computing device 610 may attempt to identify a feature vector associated with the item in which the feature vector is a vector floating number representation of image of item as captured by camera configuration 670 in which the feature vector includes a depiction of the visual features of the item.

The feature vector may be generated from the pixels of the image of the item captured by camera configuration 670 and then generates a matrix of data that is implemented into the feature vector such that the matrix of data of the feature vector depicts the visual features of the item as captured in the image of the item by camera configuration 670. Item identification computing device 610 may then automatically map the feature vector for the unknown item into the data set generated for the unknown item in which the feature vector is mapped into the data set with the POS data generated from the image parameters extracted from the images of the unknown item as well as the POS record for the transaction in which item identification computing device 610 failed to identify the unknown item. For example, the item may be associated with a 1024 sized feature vector in which the 1024 sized feature vector when analyzed includes a depiction of the visual features of the item in which the feature vector is basically the biometric of the image of the item as captured by camera configuration 670. Thus, different items may have different feature vectors based on the different visual features between the different items as captured by the images of the different items by camera configuration 600.

Each time that the unknown item is positioned at the POS system and item identification computing device 610 fails to identify the unknown item, item identification computing device 610 may recognize that the feature vectors for the unknown item in each transaction are similar thereby indicating that the visual features of the unknown item in each transaction are similar. In doing so, item identification computing device 610 may associate the feature vectors that are similar to each of the transactions of the unknown item as actually identifying the unknown item. The mapping of the feature vectors and the POS data to the POS record that is specific to the transaction in which item identification computing device 610 fails to identify the unknown item enables several data sets each with similar feature vectors associated with the unknown item to be generated thereby enabling item identification computing device 610 to associate the feature vectors in each of the data sets and identify the unknown item.

The automatic generation of data sets with feature vectors then enables continuous training in that item identification computing device 610 may then provide each of the several data sets with the feature vectors associated with the unknown item to neural network 640 in which neural network 640 may then train the feature vectors associated with each of the data sets for the unknown item to identify the unknown item. Each of the data sets with the feature vectors that are generated from each transaction in which item identification computing device 610 fails to identify the item may have feature vectors that are similar as the feature vectors are generated from the images of the unknown item during each transaction may be similar as such images are captured of the same unknown item.

As a result, item identification computing device 610 may be able to adapt and recognize subtle changes in the packaging and presentation of an item. Regardless of the subtle changes in the packaging and presentation of an item, the item remains the same item. As discussed above, the standard twelve ounce can of Coke is the same item as the twelve ounce can of holiday Coke despite the color and design of the twelve ounce can of holiday Coke differing from the standard twelve ounce can of Coke. The mapping of the feature vectors of the same item with subtle changes in packaging and presentation of an item to the POS record as well as the images captured of the item to automatically generate the data set for the item may provide item identification computing device 610 the flexibility differentiate between the subtle changes in the packaging and presentation of an item while still recognizing the items without the need of offline training.

Often times, a subtle change in packaging and presentation of an item is regionally based and for a specific duration of time. The mapping of the feature vectors of such items to the POS record to automatically create the data set for each POS record may enable item identification computing device 610 to adapt to subtle changes in packaging and presentation of an item that is regionally based. For example, the color and design of the Monster Energy Drink may change in the Kansas City region when the Kansas City Chiefs are playing the Super Bowl for a duration of time before the Super Bowl and then until such modified Monster Energy Drinks are sold by the retail locations in the Kansas City region. Such a color and design change of the Monster Energy Drink is limited to the retail locations in the Kansas City region only while the retail locations outside of the Kansas City region continue to have the standard Monster Energy Drink.

Identification computing device 610 may automatically map the feature vectors of the items with the subtle change in packaging for the region to the POS record to automatically generate the data sets for such items requested for purchase in the retail locations in the region. The automatic mapping of the feature vectors to such items to the POS record may enable the identification computing device 610 to recognize that the subtle changes in packaging are regionally based due to the data provided in the POS record that specifies the location in which the feature vectors were captured from the items. Identification computing device 610 may learn simply by online training to recognize the subtle change in packing for the region for the item as being the same item that is still recognized outside of the region with the standard packaging. As a result, item identification computing device 610 may adapt to subtle changes in packaging of an item even when the subtle changes in packaging are limited to a region.

Thus, the automatic mapping of feature vectors to the POS record to automatically generate the data set may enable item identification computing device 610 may adapt to subtle changes in packages in packaging of an item without having to rely on offline training but rather doing so with online training. Without automatically mapping the feature vectors to the POS record for automatic continuous learning in an online manner, retailers would have to execute such learning via offline training in which the national team of the retailer would have to pre-emptively obtain the items with subtle changes in packaging and then pre-emptively train on such items before the items are delivered to the retail locations and stocked on the shelves. In failing to do such offline training, the items with subtle changes in packaging would then fail to be recognized when presented for purchase at the POS system. As discussed above, retailers do not have control over their supply chain in which retailers do not know when the items with subtle changes in packaging are arriving at their retail locations and when such items are ultimately sold and no longer on the shelves. Offline training of such items with subtle changes in packaging is not feasible for retailers. As a result, the automatic continuous training in an online manner with the mapping of feature vectors to the POS records may enable item identification computing device 610 to identify the subtle changes in packaging of the same item without hindering the retailer.

Item identification computing device 610 may continuously stream POS data as automatically extracted from the item parameters associated with each item positioned at a plurality of POS systems from the corresponding plurality of images captured of each item positioned at each corresponding POS system that fails to be identified to item identification server 630 for neural network 640 to incorporate into the determination of identified item parameters for each of the items positioned at each corresponding POS system. Rather than learn from the capturing of POS data for unknown items at a single POS system or even POS systems located at a single retail location, item identification computing device 610 may learn via distributed learning in which item identification computing device 610 may learn from the capturing of POS data for any unknown item positioned at any POS system at any retail location. Each retail location may act as a node in which the POS data extracted from any unknown item as mapped to each POS record for any unknown item generated at any retail location may be shared with each of the other retail locations.

Item identification computing device 610 may automatically receive updated streamed POS data associated with each image captured of each item previously positioned at each corresponding POS system as trained by neural network 640 based on machine learning as neural network 640 continuously updates the streamed POS based on the past POS data as captured from past images captured of each item positioned at each of the POS systems. Neural network 640 may be trained on with in an increase in POS data associated with each item that fails to be identified to match due to an increase in the POS systems that each item is positioned and fails to identify each item. In doing so, the duration of time to execute the iterations required for the neural network 640 to train on the POS data of an unknown item for item identification computing device 610 to identify the unknown item is significantly reduced. Rather than waiting to execute an iteration each time the unknown item is positioned at a POS system at a single retail location, iterations may be executed each time the unknown item is positioned at any POS system at any retail location. The POS data for the unknown item may be mapped to each POS record and provided to neural network 640 to train on at a significantly increased rate due to the increase in the quantity of times the unknown item is positioned at any POS system at any retail location resulting in a significantly decrease in duration of time required for item identification computing device 610 to identify the unknown item.

Item identification computing device 610 may analyze the updated streamed POS data as provided by neural network 640 based on the POS data provided by each of the POS systems to determine the plurality of identified item parameters associated with each item currently positioned at each POS system that failed to be identified when previously positioned at each POS system. Item identification computing device 610 may automatically identify each corresponding item currently positioned at each POS system when the identified item parameters associated with each item as provided by neural network 640 when combined match the corresponding combination of item parameters associated with each item as stored in item parameter identification database 620. Each corresponding item may be automatically identified in a decreased duration of time due to the increase in the POS data associated with each item based on the increase in the POS systems that each item previously failed to be identified.

For example, item identification computing device 610 may extract the POS data from the images captured of the twelve ounce can of holiday Coke each time the twelve ounce can of holiday Coke is positioned at any POS system at any retail location for purchase. Rather than waiting to automatically map the POS data to the POS record each time the twelve ounce can of holiday Coke is positioned at the POS system at a single location to generate a data set, item identification computing device 610 may do so each time the twelve ounce can of holiday Coke is positioned at any POS system at any retail location. In doing so, the data sets for the twelve ounce can of holiday Coke are generated at a significantly increased rate as compared to simply creating the data set at a single location. The increase rate in which the data sets are generated and then provided to neural network 640 at an increased rate thereby enabling neural network 640 to train on the data sets at an increased rate. As a result, item identification computing device 610 may identify the twelve ounce can of holiday Coke in a decreased duration of time as compared to simply waiting for the data sets to be generated when the twelve ounce can of holiday Coke is presented at a single retail location.

Item identification computing device 610 may identify each item positioned at the POS system regardless of the orientation of each item when positioned at the POS system. Item identification computing device 610 does not require that the customer position each item face up one at a time at the POS system in order to identify each item positioned at the POS system. Rather, item identification computing device 610 may adapt to however the customer positioned the items at the POS system for purchase. Item identification computing device 610 may recognize that each customer may position the items that each customer may request to purchase in a different manner. For example, a first customer may throw the items in which the first customer requests to purchase on the POS system. A second customer may stack the items in which the second customer requests to purchase on the POS system. Rather than have each customer position each item at the POS system one at a time and face up such that item identification computing device 610 may identify a single orientation of each item, neural network 640 may train on the POS data for each data set of each POS record for each item to adapt to the orientation of each item regardless of how each item is positioned at the POS system.

In doing so, the customer is not requested by item identification computing device 610 to move items after the customer initially positioned the items that the customer requested to purchase at the POS system in order for item identification computing device 610 to identify each of the items positioned by the customer at the POS system. The customer is not requested by item identification computing device 610 to move items to position each item a father distance from each other such that item identification computing device 610 may be able to identify each item. Item identification computing device 610 may be able to identify each item regardless as to whether a first item is positioned in front of a second item thereby not requiring the customer to move the first item a distance from the second item so that item identification computing device 610 may differentiate between the first item and the second item. The customer is also not requested to remove items that the customer initially positioned at the POS system such that item identification computing device 610 may identify each item individually at a time without the obstruction of other items positioned at the POS system by the customer and then request the customer to then position back each removed item such that item identification computing device 610 may then identify each subsequent item without obstruction from other items.

Rather, item identification computing device 610 may adapt to the orientation as well as the quantity of items positioned at the POS system by the customer without requesting the customer to execute additional tasks in order for item identification computing device 610 to adequately identify each of the items positioned at the POS system by the customer. In doing so, item identification computing device 610 may identify the items positioned at the POS system by the customer in any manner, orientation, and/or combination such that the customer is not required to position the items that the customer requests to purchase in a different manner. Each time that the item is positioned at a corresponding POS system in a specific orientation and relative to the positon of other items, item identification computing device 610 may automatically generate the feature vector of the item based on the specific orientation of the item at the POS system as well as relative to other items positioned at the POS system and automatically generate a data set for the feature vector of that item as mapped to the POS record for that transaction in which the item was positioned in a specified orientation and relative to other items positioned at the POS system at the time of the transaction.

The feature vector and corresponding POS data included in the data set for the item as mapped to the POS record at the time the item was positioned at the POS system in the specific orientation and relative to other items positioned at the POS system may be automatically streamed by item identification computing device 610 to item identification server 620. Neural network 640 may then train on the data set includes POS data for the item as mapped to the POS record at the time the item was positioned at the POS system to train on that that specific orientation of the item as positioned at the POS system as well as relative to other items positioned with the item at the POS system is POS data that identifies the item. In doing so, neural network may associate the POS data included in each data set automatically generated from each item as positioned at the corresponding POS system for each transaction for each orientation of each item as well as relative to other items positioned at the POS system with the item for any transaction of the item at any retail location to thereby train and identify the item regardless of orientation as well as the positioning of the item with other items. As a result, item identification computing device 610 may automatically identify the item regardless of the orientation of the item as well as the relative to other items positioned at the POS system by the customer.

Each camera included in camera configuration 670 may be positioned such that each camera capture a different perspective of the item positioned at the POS system as oriented at the POS system as well as relative to other items positioned at the POS system. Item identification computing device 610 may then take a measurement of the unknown item and associate that measurement of the unknown item with each camera included in camera configuration 670. For example, the standard twelve ounce can of Coke when positioned at the POS system in a specific orientation and relative to other items positioned at the POS system may have a measurement identified of the standard twelve ounce can of Coke for each camera included in camera configuration 670 and then associated with each camera included in camera configuration 670. In doing so, item identification computing device 610 may identify how the standard twelve ounce can of Coke is captured by each camera included in camera configuration 670. Item identification computing device 610 may then prevent two different standard twelve ounce cans of Coke from being identified due to the different perspectives captures of the actual standard twelve ounce can of Coke captured by the different cameras included in camera configuration 670 of the actual standard twelve ounce can of Coke positioned at the POS system.

The POS data extracted from each of the images captured by each camera included in camera configuration 670 of the item and automatically mapped to the POS record of the item to automatically generate a data set may then be streamed to item identification server 630 such that neural network 640 may then train on the POS data that is indicative of the orientation of the item as well as the item positioned relative to the other items positioned at the POS system. Neural network 640 may then train on such POS data to determine the confidence level of the item identification of the item as captured by each camera included in camera configuration 670.

For example, neural network 640 may determine that based on the four items positioned at the POS system for purchase by the customer and captured by a first camera included in camera configuration 670 identifies a first item of the four items positioned at the POS system for purchase by the customer as the standard twelve ounce can of Coke with a 90% confidence level. A second camera included in camera configuration 670 identifies the first item of the four items positioned at the POS system for purchase by the customer as the standard twelve ounce can of Coke with a 99% confidence level. A third camera included in camera configuration 670 identifies the first item of the four items positioned at the POS system for purchase by the customer as the standard twelve ounce can of Coke with a 90% confidence level. A fourth camera included in camera configuration identifies the first item of the four items positioned at the POS system for purchase by the customer as a standard twelve once can of Dr. Pepper with a 50% confidence level. Neural network 640 may then provide such recognition by each camera included in camera configuration 670 and item identification computing device 610 may then based on the weighted average of the confidence level in identifying the standard twelve ounce can of Coke as captured by the images of each camera included in camera configuration 670. In doing so, item identification computing device 610 may identify the unknown item as the standard twelve ounce can of Coke regardless of the orientation of the standard twelve ounce can of Coke as well as the relative positioning of the standard twelve ounce can of Coke to the other four items positioned at the POS system by the customer for purchase.

Item identification computing device 610 may continuously stream POS to item identification server 630 such that item identification server 610 may accumulate POS data as stored in item parameter identification database 610. In doing so, item identification server 630 may continuously accumulate POS data that is associated with the capturing of images of each item as streamed by item identification computing device 610 each time an item is positioned at a corresponding POS system. The POS data is accumulated from the pixels of each image and analyzed to recognize different item parameters that are depicted by each image. Over time as the POS data is accumulated by item identification server 6300 continues to increase, neural network 640 may then apply a neural network algorithm such as but not limited to a multilayer perceptron (MLP), a restricted Boltzmann Machine (RBM), a convolution neural network (CNN), and/or any other neural network algorithm that will be apparent to those skilled in the relevant art(s) without departing from the spirit and scope of the disclosure.

Each time that POS data is streamed to item identification server 630, neural network 640 may then assist image identification computing device 610 by providing item identification computing device 610 with the appropriate recognition of the item depicted by the image to automatically adjust the recognition of the item by item identification computing device 610 to correctly recognize the item depicted by the image. Neural network 640 may assist item identification computing device 610 in learning as to the appropriate item depicted by the image based on the POS data such that neural network 640 may further improve the accuracy of item identification computing device 610 in automatically recognizing the appropriate item depicted by the image to further enhance the analysis of the image. Neural network 640 may provide item identification computing device 610 with improved accuracy in automatically recognizing the appropriate item depicted in the image such that neural network 640 may continue to learn upon with the accumulation of POS data that is provided by item identification computing device 610 and/or any computing device associated with item identification configuration 600 to item identification server 620. Thus, recognition of images depicted by images by item identification computing device 610 may further enhance the identification of previously unknown items as positioned at any POS system at any retail location.

Item identification configuration 600 may be integrated into an existing POS system as already positioned at the retail location of the retailer. Without an existing POS system already positioned at the retail location of the retailer, then there is no opportunity for the retailer to execute the check-out process to enable the customer to purchase the items that the customer requests to purchase. In integrating item configuration 600 to an existing POS system, the UPC of each item already identified by item identification computing device 610 may be provided to the existing POS system in a similar manner as the scanner does. In integrating item configuration 600 to an existing POS system, item identification computing device 600 may add additional item parameters associated with additional items currently positioned at the POS system but not registered with the POS system. Item identification computing device 600 may also remove item parameters associated with items that are not positioned at the POS system due to not being available for purchase by the customer at the retail location of the POS system.

For example, a child may position two Snicker bars at the POS system of a retail location. The parent of the child may not want the child to have two Snicker bars purchased at the POS system and may then remove one Snicker bar from the POS system. The integration of item identification configuration 600 with the existing POS system may enable item identification computing device 610 to identify that the of the two Snicker bars initially positioned at the POS system for purchase by the customer that one of the two Snicker bars has been removed from the POS system and is no longer requested for purchase by the customer. Thus, item identification configuration 600 may be POS system agnostic in which item identification configuration may be integrated with any existing POS system to enhance the adaptability of item identification configuration 600 to any existing POS system.

### Structure and Dimensions of Example Assisted Checkout Devices

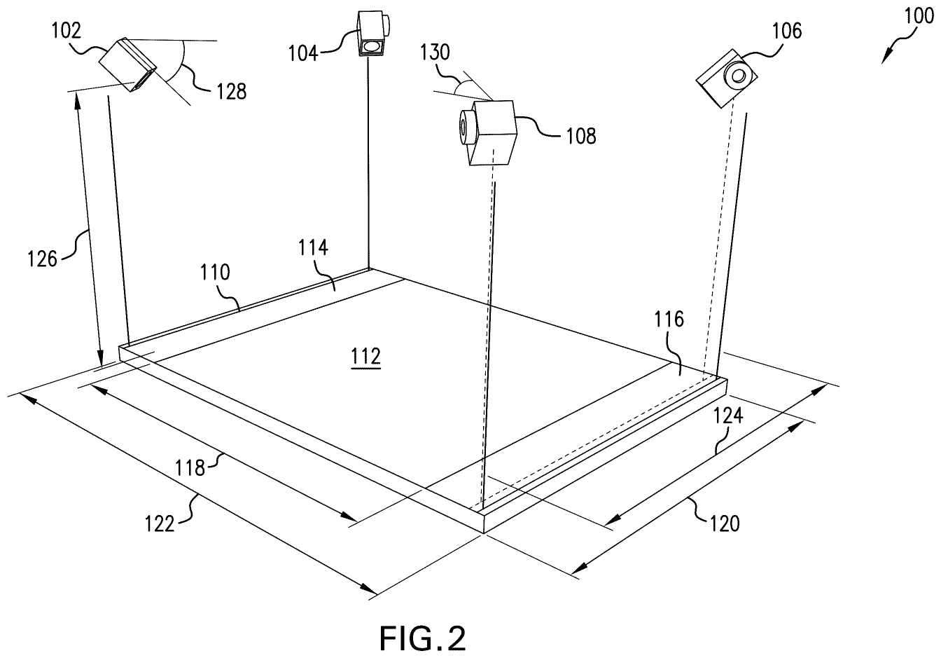

FIG. 2 shows an example device 100 for assisted checkout. A number of cameras 102, 104, 106, 108 are positioned above, and oriented downward and inward to observe from different angles, a checkout plane 112, which can, in some examples, be on the upper surface of a structural base 110 of the device 100. Although the illustrated example device 100 shows four cameras 102, 104, 106, 108 observing the checkout plane 112, other embodiments may have more or fewer cameras. For example, in some embodiments, a fifth camera (not shown in FIG. 2) may be placed directly above the checkout plane 112, e.g., directly above about the geometric center of the checkout plane, oriented to look directly down on the checkout plane 112, normal to the surface of the base 110. In other embodiments, the base 110 can be transparent and a fifth camera can be positioned below the checkout plane 112, oriented to look directly up at the checkout plane 112. Some examples of the device 100 may rigidly define the positions and/or orientations of the cameras 102, 104, 106, 108 relative to the checkout plane 112 via support posts for the cameras 102, 104, 106, 108 that are affixed to the base 110. Other examples of the assisted checkout device 100 may omit the base 110 and instead provide the cameras 102, 104, 106, 108 as suspended from overhead of the checkout plane 112. For example, the cameras 102, 104, 106, 108 can be rigidly affixed to a frame or ring that can be hung from a ceiling of a store.

In some examples, the checkout plane 112 may be defined by the base 110 of the assisted checkout device 100 via structural features indicative of a boundary, such as walls, lights, surface textures, surface materials, surface colors, surface elevations, or markings. This boundary may serve either as an indicator to a customer using the assisted checkout device 100 that only items placed wholly within the confines of the boundary should be expected to be properly observed by the cameras 102, 104, 106, 108 and added to a checkout list of items for purchase, or as self-enforcing structural feature requiring items for checkout to be placed within the confines of the boundary. In the illustrated example shown in FIG. 2, the boundary of the checkout plane 112 is defined by margins 114, 116, which can, for example, be of different color, texture, surface material, or elevation. The checkout plane 112 can be square, rectangular, circular, oval, or of any other two-dimensional shape. In the illustrated example, the checkout plane 112 is square/rectangular. In examples having a square or rectangular checkout plane 112, the checkout plane 112 has a first dimension 118 and a second dimension 120. In some examples, the first dimension 118 is between about 24 inches and about 36 inches, e.g., about 24 inches. In some examples, the second dimension 120 is between about 12 inches and about 30 inches, e.g., about 24 inches. In some examples, the second dimension 120 may be shorter than the first dimension 118. The illustrated example has a checkout plane 112 that is 2 feet by 2 feet. Other examples may have different dimensions, such as 2 feet by 3 feet.

In examples having a structural base 110, the base 110 of the assisted checkout device 100 can, for example, have dimensions equal or greater than the checkout plane 112. For example, the base 110 can be square or rectangular having a first dimension 122 and a second dimension 120. In the illustrated example, the second dimension of the base 110 is equal to the second dimension 120 of the checkout plane 112. In some examples, the first dimension 122 of the base 110 is between about 24 inches and about 44 inches, e.g., about 32 inches. In some examples, the second dimension 120 of the base 110 is between about 12 inches and about 30 inches, e.g., about 24 inches. In some examples, the second dimension 120 may be shorter than the first dimension 122. The illustrated example has a base 110 that is 24 inches by 32 inches. Other examples may have different base dimensions, such as 24 inches by 44 inches.

The cameras 102, 104, 106, 108 may be positioned with their focal points above the checkout plane 112 each by the same camera height or by a different camera height for each camera. In the illustrated example of FIG. 2, the focal points of all of the cameras 102, 104, 106, 108 are positioned above the base by the same camera height 126. For example, the focal points of the cameras 102, 104, 106, 108 may be positioned above the base at a camera height 126 of between about 10 inches and about 25 inches, e.g., between about 15 inches and about 20 inches. In the illustrated example, the cameras 102, 104, 106, 108 are positioned with their focal points above the base at a camera height of 18.1374 inches. In the illustrated example, the cameras 102, 104, 106, 108 are each positioned with their focal points offset from the geometric center of the checkout plane 112 by 15.5 inches in a first horizontal dimension and by 11.5 inches in a second horizontal dimension. In other examples, the respective horizontal positions of the cameras 102, 104, 106, 108 can vary and can depend on the size of the base 110 and/or the fields of view of the respective cameras 102, 104, 106, 108.

The cameras 102, 104, 106, 108 can be oriented to look down at the checkout plane 112 so as to have a variety of views of items placed on the checkout plane 112. In some examples, the cameras 102, 104, 106, 108 can each be oriented to have their respective optical axes point at about a same point in three-dimensional space (e.g., at a point above the geometric center of the plane 112), as in the illustrated example, or in other examples they can each be oriented to have their respective optical axes point at different respective points in three-dimensional space above the checkout plane 112. The cameras 102, 104, 106, 108 can each be oriented at a downward vertical angle (a downward tilt angle) 128 that can be dependent on their respective camera heights above the checkout plane 112. As an example, the cameras 102, 104, 106, 108 can each be oriented at a downward tilt angle 128 of between about 40° and about 50°, e.g., about 44°, from level horizontal. The cameras 102, 104, 106, 108 can each be oriented at an inward horizontal angle (an inward pan angle) 130 that can be dependent on their respective horizontal-dimension positions with respect to the geometric center of the checkout plane 112. As an example, the cameras 102, 104, 106, 108 can each be oriented at an inward pan angle 130 of between about 30° and about 50°, e.g., between about 39° and about 40°, as measured from an outer dimension, e.g., dimension 118 in the illustrated example. It should be appreciated that the downward title angle and the inward pan angle of each of the cameras 102, 104, 106, 108 may be independent of those of the other cameras 102, 104, 106, 108 (e.g., as dictated by the heights and/or other geometrical relationships of the respective cameras).

As illustrated in other drawings discussed in greater detail below, the cameras 102, 104, 106, 108 can be provided on rigid posts attached to the base 110 that fix their positions and orientations relative to the base 110 and the plane 112. Providing the cameras 102, 104, 106, 108 as fixedly coupled to the base 110 offers the advantage that the assisted checkout device 100 can be provided (e.g., shipped to a store) either as a single component that is already fully assembled or as a small number of components that are easily assembled, e.g., without special tools, training, or instructions, the structural assembly of which enforces desired or determined optimal camera placements and orientations that are unalterable during the regular course of checkout use, thus ensuring consistency of operation over the lifetime of the assisted checkout device 100.

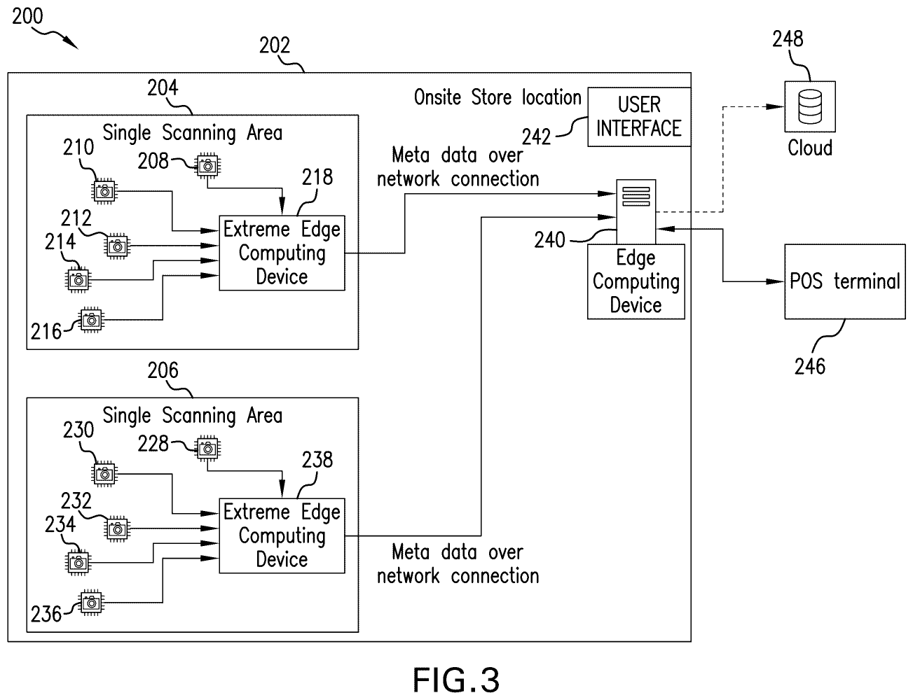

As described in greater detail below with respect to FIG. 3, each of the cameras 102, 104, 106, 108 (along with, in some examples, any other cameras associated with the assisted checkout station provided with assisted checkout device 108) can be wired or wirelessly coupled to a computing device, referred to herein as an extreme edge computing device, configured to receive and process video streams from the multiple cameras to which it is coupled. The extreme edge computing device runs software that provides a computer vision backend for the assisted checkout device 100, recognizing items placed on the checkout plane 112 as known items stored in a database of such items. Because this recognition is machine-vision-based, it does not require individual scanning of identifying markings (e.g., UPC barcodes) of the items placed for checkout. The backend generates, based on provided video stream inputs, a checkout list of items detected as placed on the checkout plane 112. In some examples, the extreme edge computing device (not shown in FIG. 2) can be concealed underneath a checkout counter on which the assisted checkout device 100 is placed, or in a nearby drawer or cabinet or other secure location. In other examples, the extreme edge computing device can be integrated into the base 110, or otherwise into some other part of the assisted checkout device 100.

The assisted checkout device 100 can also be provided with one or more visual displays (not shown in FIG. 2) that provide a frontend for the device 100. For example, the one or more visual displays can be coupled to the extreme edge computing device, or to another computing device that is, in turn, coupled to the extreme edge computing device. Each of the visual displays, for example, can be a tablet computing device having a touchscreen. The one or more visual displays collectively form a frontend for the assisted checkout device 100 that can be configured to display the checkout list generated by the backend. In some examples, the assisted checkout device 100 is provided with a first, customer-facing visual display and a second, cashier-facing visual display. The second, cashier-facing visual display can, in some examples, provide an interactive user interface (UI), e.g., a graphical user interface (GUI), permitting a cashier to add or remove items to or from the checkout list automatically generated by the backend. The first, customer-facing visual display can be equipped with payment acceptance functionality (e.g., a reader for a credit card or mobile phone) and can, in some examples, provide an interactive UI or GUI permitting a customer to tender cashless payment via the first visual display. In some examples, the temporal update rate of the revision of the checkout list on the frontend device(s) can be limited, e.g., to about 1 hertz.

### In-Store Connectivity of Example Assisted Checkout Devices

FIG. 3 shows a block diagram of an example assisted checkout system 200 within a single store 202. The store 202 can have multiple assisted checkout stations 204, 206 each equipped with an assisted checkout device, such as the assisted checkout device 100 of FIG. 2. The example illustrated in FIG. 3 has two checkout stations 204, 206, but other examples can have more or fewer assisted checkout stations. Each assisted checkout station can include a number of cameras and an associated extreme edge computing device. In the illustrated example, a first extreme edge computing device 218 at the first assisted checkout station 204 is coupled to receive video streams from five cameras 208, 210, 212, 214, 216, and a second extreme edge computing device 238 at the second assisted checkout station 206 is coupled to receive video streams from five other cameras 228, 230, 232, 234, 236. For example, cameras 210, 212, 214, and 216 in FIG. 3 can correspond to cameras 102, 104, 106, and 108 in a first instance of the assisted checkout device 100 of FIG. 2, and camera 208 in FIG. 3 can correspond to a fifth (e.g., overhead) camera, not shown in FIG. 2, for the first assisted checkout station 204. Similarly, cameras 230, 232, 234, and 236 in FIG. 3 can correspond to cameras 102, 104, 106, and 108 in a second instance of the assisted checkout device 100 of FIG. 2, and camera 228 in FIG. 3 can correspond to a fifth (e.g., overhead) camera, not shown in FIG. 2, for the second assisted checkout station 206.

The cameras 208, 210, 212, 214, 216, 228, 230, 232, 234, and 236 can be coupled to their respective extreme edge computing devices 218, 238 using any suitable wired or wireless link or protocol. Providing the camera links as direct wired links, e.g., over USB, as opposed to indirect wired links or wireless links, e.g., over internet protocol (IP), has dependability and robustness advantages, in that each assisted checkout system need not be reliant on local area network (e.g., Wi-Fi) internet connectivity within the store 202, which may be slow, congested, or intermittent.

The extreme edge computing devices 218, 238 can each be any computing system capable of receiving and processing video streams from their respective cameras. In some examples, each extreme edge computing device 218, 238 is equipped with an AI acceleration unit, e.g., a graphics processing unit (GPU) or tensor processing unit (TPU), to provide the computing capability that may be required to process the video streams in accordance with computer vision methods described in greater detail below. In some embodiments, the extreme edge computing devices 218, 238 can include a complete computer system with an AI acceleration unit and a heat sink in a self-contained package. Provided with video streams from their respective video cameras, each extreme edge computing device 218, 238 derives and outputs metadata indicative of items detected on a checkout plane of a respective checkout station 204 or 206. In some examples, not shown in FIG. 3, a single extreme edge computing device can be coupled to the cameras from multiple (e.g., two) assisted checkout stations and can perform video stream receipt and processing functions for all of the multiple assisted checkout stations for which it is connected to cameras. The handling of multiple assisted checkout stations by a single extreme edge computing device reduces system costs and increases operational efficiency.

Each extreme edge computing device 218, 238 can, in turn, be wired or wirelessly coupled to another computing device 240 located on-site within the store 202, referred to herein as an edge computing device, e.g., over various network connections such as an Ethernet or Wi-Fi local area network (LAN) using an internet protocol. In some examples (not shown), the store 202 is provided with multiple edge computing devices 240. Each edge computing device 240 is likewise equipped with an AI acceleration unit (e.g., GPU or TPU) to provide the computing capability that may be required to train or re-train machine learning (ML) models as described in greater detail below. A POS terminal 246, or multiple such terminals, can be coupled to the edge computing device 240 (as shown) and/or to individual ones of the extreme edge computing devices 218, 238 (not shown). Each edge computing device 240 can communicate (e.g., over the internet) with remotely hosted computing systems 248 configured for distributed computation and data storage functions, referred to herein as the cloud.

The edge computing device 240 can configure and monitor the extreme edge computing devices 218, 238 to which it is connected to enable and maintain assisted checkout functionality at each assisted checkout station 204, 206. For example, the edge computing device 240 can treat the extreme edge computing devices 218, 238 as a distributed computing cluster managed, for example, using Kubernetes. An edge computing device in a store can thus provide a single point of contact for monitoring all of the extreme edge computing devices in the store, through which all of the edge computing devices can be managed, e.g., remotely managed over the cloud via a web-based configuration application. Advantageously, each store can be provided with at least two extreme edge computing devices 218, 238 to ensure checkout reliability through system redundancy. The edge computing device 240 can also receive data and metadata from the extreme edge computing devices 218, 238, enabling it to train or retrain ML models and thus improve assisted checkout functionality over time. In some examples, the edge computing device 240 and the extreme edge computing devices 218, 238 can be accessed and configured via a user interface (UI) 242, e.g., a graphical user interface (GUI), that can be accessible via a web browser.

In some examples, not shown in FIG. 3, one or more cameras associated with an assisted checkout station 204, 206 can connect directly to the edge computing device 240, rather than to the corresponding extreme edge computing device 218, 238. For example, an assisted checkout device at an assisted checkout station may have four USB cameras coupled to its associated extreme edge computing device, and a fifth (e.g., overhead) camera that is an IP camera that streams via wired or wireless connection to the store's edge computer device. In some examples, metadata derived from the video stream data from the fifth (IP) camera, generated at the edge computing device, can be merged at the edge computing device with metadata derived from the video stream data from the four USB cameras, generated at the extreme edge computing device associated with the checkout station, to provide an enhanced interpretation of the scene observed by all five cameras associated with the checkout station. The combination of AI-acceleration-unit-enabled extreme edge computing devices and an AI-acceleration-unit-enabled edge computing device can thus result in more efficient distribution of data processing tasks while simplifying infrastructure setup and maintenance and reducing network bandwidth that would otherwise be associated with streaming all assisted checkout camera outputs directly to an edge computing device over a local area network. Although described by way of example as connecting to another fifth (e.g., overhead) camera, it should be appreciated that many cameras may connect directly to the edge computing device 240 (e.g., some or all of the cameras in an existing security camera infrastructure) in some embodiments.

In some examples, the edge computing device 240 can be used to collect visual analytics information provided by a visual analytics system running on the edge computing device 240. The visual analytics information can include information about individual customer journeys through the store: paths taken through the store, items observed or interacted with (e.g., picked up), areas of interest entered (e.g., a coffee station, a beverage cooler, a checkout queue, a checkout station), and other gestures, behaviors, and activities observed. Advantageously, such information can be garnered from existing security camera infrastructure without using facial recognition or obtaining personally identifying information (PII) about the customers observed in the store. The edge computing device 240 can collate this video analytics information and combine it with information from the assisted checkout extreme edge computing devices 218, 238, such as checkout list predictions, to produce more accurate checkout list predictions on the edge computing device 240. In some examples, the video analytics information can be used for checkout, e.g., to produce a checkout list, without the use of an assisted checkout device 100.

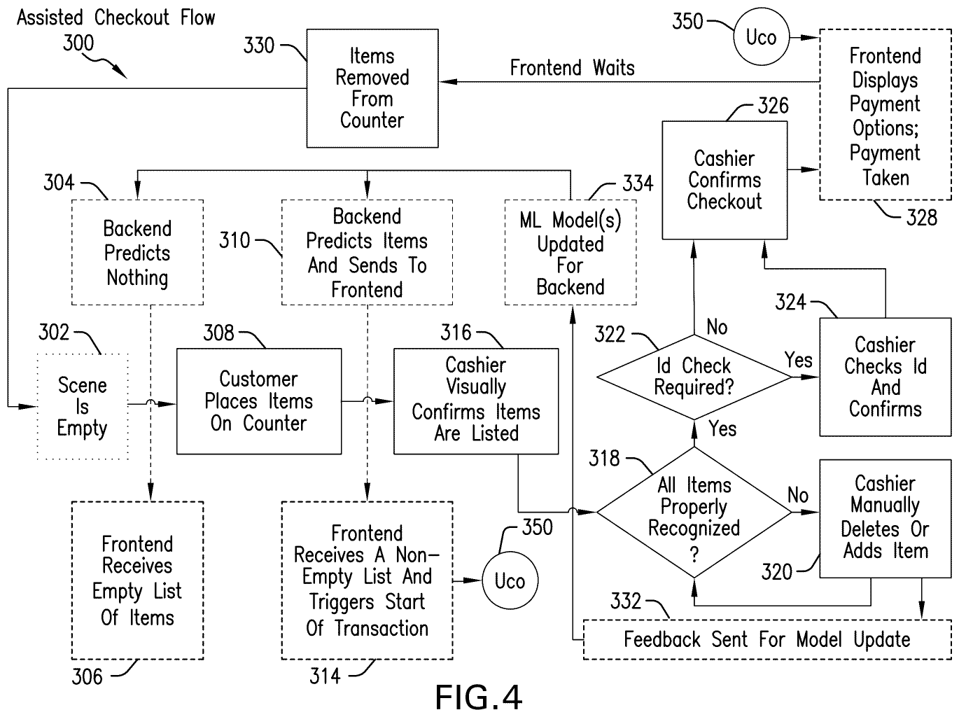

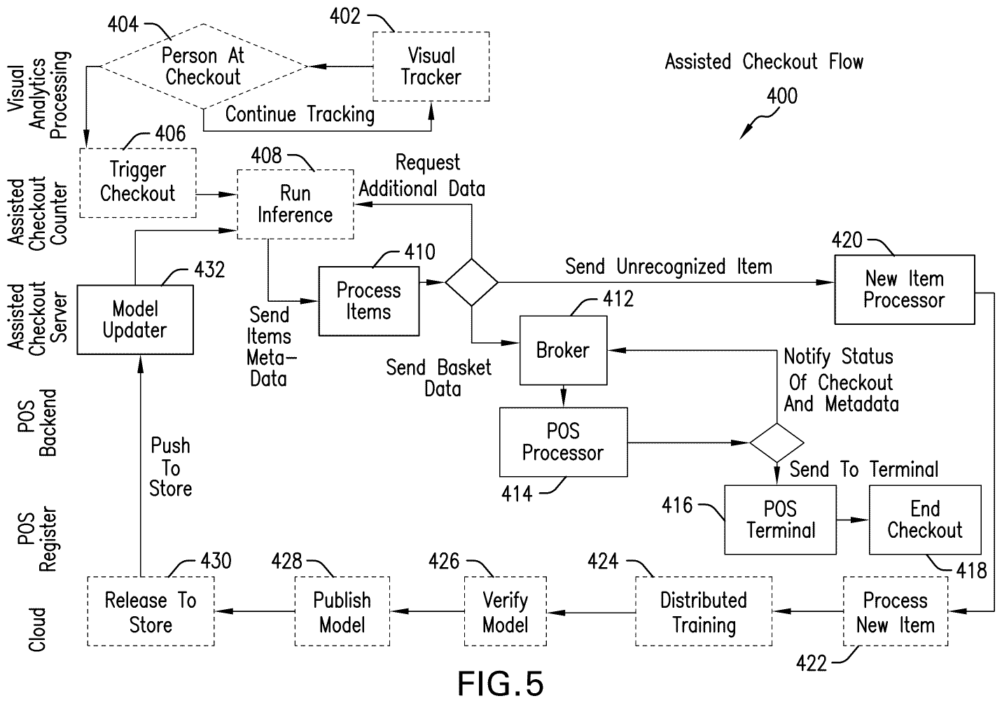

In some examples, inferencing using ML models, including those for detecting items and predicting what items appear in a scene, can be run on the extreme edge computing devices 218, 238, such that ML computational tasks are only offloaded to the edge computing device 240 for incremental training of ML models in real time. In the most frequent examples of operation of assisted checkout, each extreme edge computing device 218, 238 may send only generated metadata, rather than video streams or image data, to the edge computing device 242. The edge computing device 242 can be configured to maintain databases of items and sales, can communicate with the POS terminal 246, and can store feedback from the POS terminal 246. In some examples, each extreme edge computing device 218, 238 can operate generally to stream generated metadata unidirectionally to the edge computing device 240, by deriving still images from video streams and processing the still images to determine predictions regarding items in an observed scene over the checkout plane. ML learning, collection of feedback from cashiers, communicating with the POS, and storing of metadata can all take place on the edge computing device 242. As described in greater detail below with regard to FIGS. 4 and 5, feedback from the cashiers collected by the edge computing device 242 can, in some examples, be used to train ML models either on the edge computing device 242 or on the cloud. Newly trained or re-trained ML models can be provided from the edge computing device 242 back to the extreme edge computing devices 218, 238.

### Examples of Assisted Checkout Flow

FIG. 4 illustrates example functioning 300 of an assisted checkout device or system such as are respectively illustrated in FIGS. 2 and 3. The spatial volume over an assisted checkout plane (e.g., plane 112 in FIG. 2) of an assisted checkout station (e.g., station 204 or 206 in FIG. 3), as observed by associated cameras of a respective assisted checkout device (e.g., the device 100 of FIG. 2) is referred to herein as a scene. Initially, with no items placed on the assisted checkout plane, the scene is empty 302. The backend of the assisted checkout device therefore makes no predictions 304 as to the contents of the checkout list, and the frontend, as embodied, e.g., as one or more visual displays of the assisted checkout device, receives an empty list of items 306.

Subsequently, when a customer places items on the checkout counter 308, that is, on the checkout plane within view of the cameras of the assisted checkout device, the backend predicts the items placed on the checkout plane, generates a checkout list of the predicted items, and sends the generated checkout list to the frontend 310. The backend can also generate a quantification of confidence that the predicted checkout list is accurate and complete. For example, based on one or more items placed for checkout being recognized as observable by the assisted checkout device, but unidentifiable as particular items within the database of known items available for sale, the assisted checkout device can generate a low confidence indicator, which, in turn, can be used to generate an alert to the cashier. The alert can be displayed on the frontend, and/or can be indicated by lights on the assisted checkout device 100, e.g., built into the base or other portions of the assisted checkout device 100. For example, such lights could flash, or change color (e.g., from green to red), thereby alerting the cashier to an item recognition fault requiring manual intervention by the cashier.

Based on at least one presented item being successfully recognized as within the database, the frontend receives a non-empty list and triggers the start of a checkout transaction 314. At this point, any of several things can happen to complete the transaction. In some instances, a customer may begin the checkout process when the checkout station is initially unattended by a cashier. The assisted checkout device 100 may be enabled under certain conditions to complete the checkout process unattended. For example, based on (a) the backend of the assisted checkout device 100 reporting a confidence in the accuracy of the generated checkout list that exceeds a threshold, (b) the checkout list not including any items that require age verification (e.g., alcohol, nicotine, or lottery items), and (c) the customer indicating that payment is to be made without cash (e.g., by credit or debit card, or by using an electronic payment completed using a cellphone, or with a rewards card or certain coupons, or in accordance with a promotion) or cash handling equipment, the assisted checkout device 100 can proceed with unattended checkout (UCO) 350, if enabled to do so. With unattended checkout, the frontend of the assisted checkout device 100 displays payment options and takes payment 328. Although not shown in FIG. 4, payment information can be transmitted to a local database store. Having completed the checkout process, including the purchase transaction, the customer may then remove purchased items from the checkout counter 330 and leave the store.

Based on any of (a) the assisted checkout not being enabled for unassisted checkout, (b) the backing reporting a confidence in the accuracy of the checkout list that does not meet the threshold, (c) the checkout list containing items requiring age verification, (d) the customer not providing a cashless payment or otherwise indicating (e.g., through a GUI on the customer-facing visual display) that payment is to be made by cash or another method requiring cashier attendance, (d) a visual analytics system determining that the customer has one or more items not placed in the scene (e.g., a hot coffee or prepared food item, or an item that has been pocketed or otherwise concealed by the customer) or (e) the customer otherwise waiting for a cashier or indicating a need for help by the cashier, the checkout process may be continued as an attended checkout. If a cashier is not present at the assisted checked station, the cashier may be automatically alerted to attend the assisted checkout station. The cashier may then visually confirm that the generated checkout list (e.g., as displayed on a cashier-facing visual display) is accurate, e.g., that the checkout list contains no falsely recognized items and does not lack any unrecognized items or items that were not placed on the checkout plane.

In some examples, this confirmation by the cashier can be performed by the cashier looking at the list and looking at items placed on the checkout counter and/or withheld from the checkout counter by the customer, and comparing the list with the items presented for checkout on the checkout plane and/or withheld by the customer. In some examples, the assisted checkout device can provide, e.g., on a cashier-facing visual display monitor, a visual cue indicating which items placed on the checkout plane are unrecognized and thus are not entered on the checkout list. The visual cue can be, for example, a highlighting of the item in a video presentation derived from one or more of the cameras of the assisted checkout device. The highlighting can take the form of an adjusted brightness or contrast of the item in the video presentation, an outline or bounding box surrounding the item in the video presentation, or other form. The displayed visual cue can save the cashier time in determining which item or items on the checkout plane are unrecognized and require manual intervention to add to a checkout list. Any items not placed on the checkout plane (e.g., a cup of hot coffee preferred to be held by the customer and not placed on the checkout plane) can be scanned or otherwise entered for purchase either through the frontend or through a separate checkout system. Based on the cashier determining that all items in the scene have not been properly recognized and/or not all items presented for checkout have been listed on the checkout list 318, the cashier accordingly manually deletes or adds items to the list 320, e.g., using the GUI on the cashier-facing visual display.

In some examples, the manual deletion of falsely recognized items or the manual addition of unrecognized items can be performed by pressing quantity minus or quantity plus buttons on the GUI of the cashier-facing visual display. For example, if the checkout list erroneously includes an item confirmed by the cashier not to have been placed on the checkout plane, the cashier can locate the corresponding item on the list and press an associated quantity minus sign (−) button on the GUI to remove the item from the checkout list (or to decrement the number of identical items included on the checkout list). As another example, if the list erroneously includes too few of several identical items presented for checkout, the cashier can locate the corresponding item on the displayed checkout list and press an associated quantity plus sign (+) button to increment the number of identical items included on the checkout list.

In some examples, the cashier may manually intervene in the presentation of the items to the assisted checkout device, and may rearrange the items on the checkout plane to obtain a notably more accurate checkout list. For example, the cashier may spatially separate the items with respect to each other on the checkout plane, or may change the orientation of one or more items to give the cameras a better view of the items present for checkout.

In some examples, the cashier can manually scan one or more items presented for checkout to ensure their appearance on the checkout list. For example, the cashier can scan the one or more unidentified items using a UPC barcode reader or a QR code reader. Or, for example, a cashier may manually enter an identifying number for the item into the frontend or other system coupled to the assisted checkout device. In some examples, the cashier may hold the UPC barcode or QR code of an item, or other identifying marking of the item, up close to one of the cameras of the assisted checkout device, such that the item takes up a more substantial fraction of the field of view of the camera, prompting the assisted checkout device to perform an identification that is based on the UPC barcode or other identifying marking. Such identifying functionality may, for example, employ optical character recognition (OCR) to read a label of an item.

When a cashier manually enters an unrecognized item or otherwise manually adjusts a checkout list, manually entered information identifying the unrecognized item, images of the scene captured by the cameras during the checkout process, and/or metadata derived from the images can be automatically submitted 332 as system feedback data. The automatically submitted system feedback data can be used to retrain one or more ML models used by the backend to recognize items. The assisted checkout device, system of assisted checkout devices, and/or network of systems of assisted checkout devices at multiple stores can thereby learn information about the previously unrecognized item(s) and improve recognition of the items in future checkout transactions. Images or other data documenting manual overrides, such as the manually entered information identifying the unrecognized item, can be used for shrinkage reduction, e.g., theft, by a store employee or customer.

In some examples, an item may be placed on the checkout plane that is not a listed item for purchase, such as the customer's own wallet, keys, purse, or hand. Although the presence of such an item may reduce the checkout list accuracy confidence of the assisted checkout device 100 to a subthreshold value, and, in some circumstances may trigger an alert to the cashier, the cashier may exercise human discernment to safely ignore the non-inventory item presented, and confirm checkout 326.

Based on the cashier determining that all items presented for checkout have been properly recognized or manually entered 318 and are thus listed on the checkout list provided by the frontend, the cashier can then determine, e.g., based on an alert displayed on the cashier-facing visual display, whether an ID check is required 322 for any of the items presented for checkout. Based on no ID check being required for any of the items presented for checkout, the cashier can confirm the checkout 326, e.g., by pressing a “confirm” button or similar on the GUI of the cashier-facing visual display. In some examples, the assisted checkout system can interface with an automated age verification system to verify a person's age without human involvement, instead of having the cashier perform age verification. Based on an ID check being required for any of the items presented for checkout, the cashier can then ask the customer to present a valid identification document and confirm ID 324, e.g., by pressing an “ID confirmed” button or similar on the GUI of the cashier-facing display. The cashier can then proceed to confirm the checkout 326. The checkout having been confirmed, the frontend (e.g., a GUI of the customer-facing visual display) can display options for payment and, in some examples, can take payment 328. In examples in which a customer pays with cash, the cashier can take cash, make change, and use the frontend (e.g., a GUI of the cashier-facing visual display) to confirm payment. The attended checkout process is then complete, and the customer can remove the items from the checkout plane 330. The scene is then empty 302 again and the assisted checkout device thus can understand that when the scene next becomes non-empty 308, a new transaction has begun.

FIG. 5 illustrates a flow chart of example processes 400 of the assisted checkout flow, as described above with regard to FIG. 4, organized with regard to the systems used to handle the various aspects of the checkout flow. In some examples, a machine-vision-based storewide visual analytics system can operate using information from security cameras located around the store (that is, not one of the several cameras included as a part of the assisted checkout device) to track customers within the store and provide predictions as to the items picked up by a customer during the customer's journey throughout the store, which are expected to be presented for checkout. The visual analytics system can track the customer 402 and thus determine when the customer has entered certain areas of interest (AOIs) within the store, e.g., by mapping the three-dimensional location of the tracked customer to designated areas of the floor plan of the store. Such AOIs can include, as examples, a checkout queue or a checkout area. Information from the visual analytics system can be provided to the assisted checkout system (e.g., assisted checkout system 200 in FIG. 3). For example, the visual analytics system can be coupled to an edge computing device of the assisted checkout system (e.g., edge computing device 240 in FIG. 3). In some examples, the visual analytics system can share the same edge computing device as the assisted checkout system. Accordingly, the visual analytics system can inform the assisted checkout system when a person is detected to be at a checkout station 404. This information can trigger the start of a checkout transaction 406 without the use of an assisted checkout device, or can be used in conjunction with information derived from an assisted checkout device, detecting that items have been placed on a checkout plane of the assisted checkout device, to trigger the start of a checkout transaction 406. By combining information derived from the assisted checkout device and the visual analytics system, checkout triggering 406 can be made more accurate, false triggers of checkout processes can be reduced or avoided, and timing anticipation of checkouts can be made. For example, if a visual analytics system predicts, based on customer journey data, that a customer is likely proceeding to an unattended checkout station for checkout, an alert can be issued to a cashier advising attendance of the checkout station, even before the customer physically arrives at the checkout station.

The checkout process having been triggered 406, inferences are then run 408 using ML models on the backend of the assisted checkout device to attempt to recognize items placed on the checkout plane of an assisted checkout device. The inferences can be run 408, for example, on an extreme edge device of the assisted checkout device (e.g., extreme edge device 218 or 238 of FIG. 3). The inferences can, for example, use still image frames derived from video streams from cameras of the assisted checkout device to generate metadata indicative of recognized items placed on the checkout plane. As indicated in FIG. 5, the checkout trigger 406 and the inference running 408 can take place at the assisted checkout counter, that is, based on information determined at an extreme edge computing device coupled to the assisted checkout device.

In the example of FIG. 5, the metadata produced by the backend of the assisted checkout device can be provided to an assisted checkout server, e.g., edge computing device 240 in FIG. 3. The assisted checkout server can process the metadata 410 to recognize the items and can determine if additional data is needed, for example, if a cashier may be required to manually scan one or more unrecognized items. The inferences may be re-run 408 at the assisted checkout counter and the item metadata re-processed 410 at the assisted checkout server based on the provision of the requested additional data. The generated final list of checkout items and/or a checkout total (“basket data”) can be sent to a broker 412 at a point-of-sale (POS) backend. A POS processor 414 can receive input from the output of the broker 412 to process a tendered payment via an accepted method (e.g., a credit or debit card payment, or an e-payment made using a smartphone) using a POS terminal 416 at a POS register. The status of the checkout and the metadata can be provided back to the broker 412 at the POS backend in a feedback loop to ensure full payment is made, in some examples using multiple payment methods. The POS terminal 416 at the POS register receives the checkout total and accepts the payment method(s). The payment having been approved, the checkout transaction completes 418.

As discussed above with regard to FIG. 4, the assisted checkout system is capable of learning based on feedback from manual cashier intervention in the checkout process. For example, at the assisted checkout server, metadata about an unrecognized item can be sent to a new item processor 420 in the assisted checkout server. The new item processor can associate the metadata generated by ML inferencing 408 at the assisted checkout counter with manually provided item identification information. The metadata and the manually provided item identification information can be transmitted (e.g., over the internet) to the cloud system.

At the cloud, systems can process the new item 422 and conduct training or re-training of ML models, based on the feedback provided from the assisted checkout counter, using distributed computing 424 in the cloud. A newly trained or re-trained ML model can be manually or automatically verified 426, e.g., using established test data, to ensure, for example, that the newly trained or re-trained ML model does not have an unacceptably high error rate in recognizing products previously recognized accurately and with superthreshold confidence by previous versions of the ML model. The newly trained or re-trained model can then be published 428, e.g., by copying a model file containing the ML model to a location used for distribution. The newly trained or re-trained ML model is then released to the store (in some examples, to multiple stores) 430 using a push process, cither immediately upon publication of the ML model or in accordance with an ML model push schedule. The assisted checkout server (the edge computing device) receives the pushed ML model from the cloud and updates the older version of the model stored at the assisted checkout counter (the extreme edge computing device) using a model updater 432 on the assisted checkout server. The model updater 432 on the assisted checkout server can, for example, perform checks to ensure that only newer versions of models replace older versions of models at the assisted checkout counter, and not vice-versa. The model updater 432 can also queue model updating to ensure that temporarily offline assisted checkout counter devices (extreme edge computing devices) eventually have their ML models updated upon coming back online. The feedback loop of boxes 408, 420, 422, 424, 426, 428, 430, and 432 permits the system to learn and improve. There may also be multiple appearances of a SKU (or UPC code), e.g., with new or holiday packaging of an item already existing in the item database. These items with different appearances may coexist at the store for a period of time. At some point, one of the item appearances may cease to exist. The system can handle multiple appearances and also can re-train the model and remove the old appearance with or without confirmation by a human operator. Although the ML models are described herein as being “pushed” to the various stores in the illustrative embodiment, it should be appreciated that the edge computing device may, additionally or alternatively, “pull” the current/updated ML models periodically according to a predefined schedule and/or occurrence of some condition in other embodiments.

The desirability and advantages of such a learning and improvement feedback loop used as online training, as described above with regard to FIGS. 4 and 5, is underscored considering the frequency of the introduction of new items, or the revision of item packaging, that could confuse the ML models upon which inferencing is run 408 at the assisted checkout counter, along with the onerousness and potential incompleteness associated with offline training. In offline training, ML models used by assisted checkout devices to visually recognize items are trained on new items or new item packaging outside of the sale process, e.g., using dedicated training time, staff, facilities, equipment, and item inventory. Apart from the undesirable added cost associated with offline training, relying on offline training may be slow to account for introductions for sale at stores of new items or new item packaging, resulting in a lag time between such an introduction and when the associated items can be successfully recognized by unassisted checkout devices. Moreover, offline training may fail to account for regional variations in items or item packaging, such that some stores never receive a model tailored for their particular item or item packaging variations.

Online training can be conducted at the assisted checkout server, or using the cloud, or both. Online training that employs the cloud can use training inputs derived from assisted checkout devices at multiple stores, e.g., many stores located across a geographic region (e.g., across a state, a country or across the world). Online training can therefore capable of obtaining a sufficient volume of training data in a shorter period of time than could be accomplished with offline training, at reduced training expense, because training resources (e.g., training staff and training data acquisition time) are not needed to accumulate the sufficient volume of training data necessary to newly train or re-train ML model. Such training data is passively acquired by the cloud in the course of normal sale use of assisted checkout systems in stores. Online training can further eliminate the administrative expense associated with specifically keeping track of, and notifying an ML model training staff of, new items and item packaging introduced in stores.

### Non-Hierarchical Item Recognition and Hierarchical Item Recognition

Assisted checkout systems may use non-hierarchical or hierarchical ML approaches for recognition of items placed on the checkout plane. Hierarchical approaches have scalability advantages in that they may work to improve the efficiency of ML model retraining as new items available for sale are added to a store and to a database of such items.

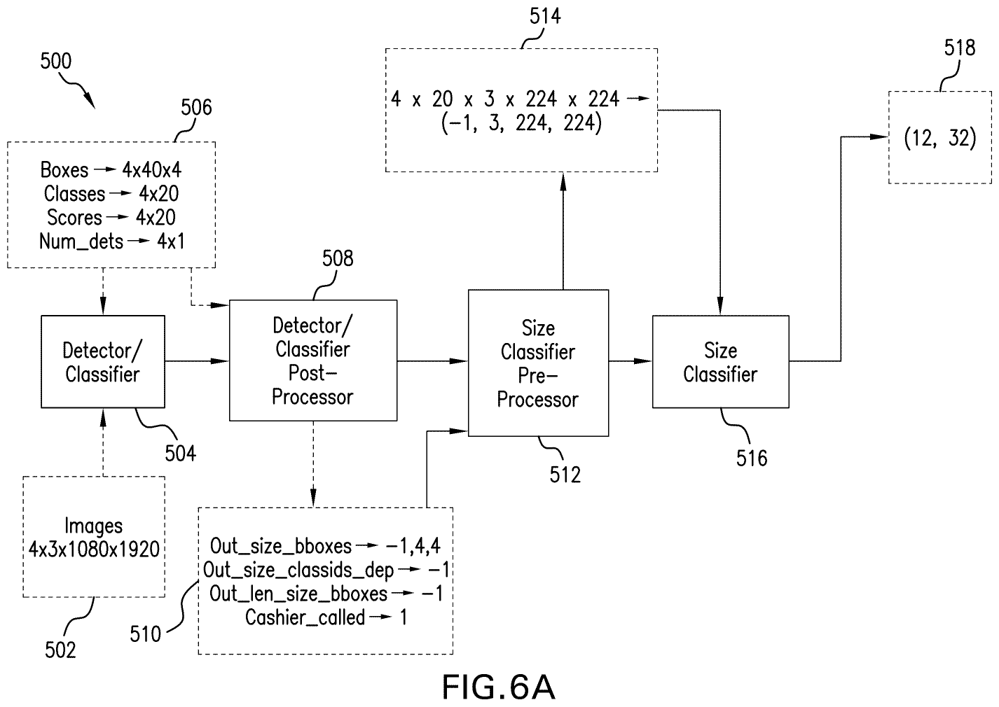

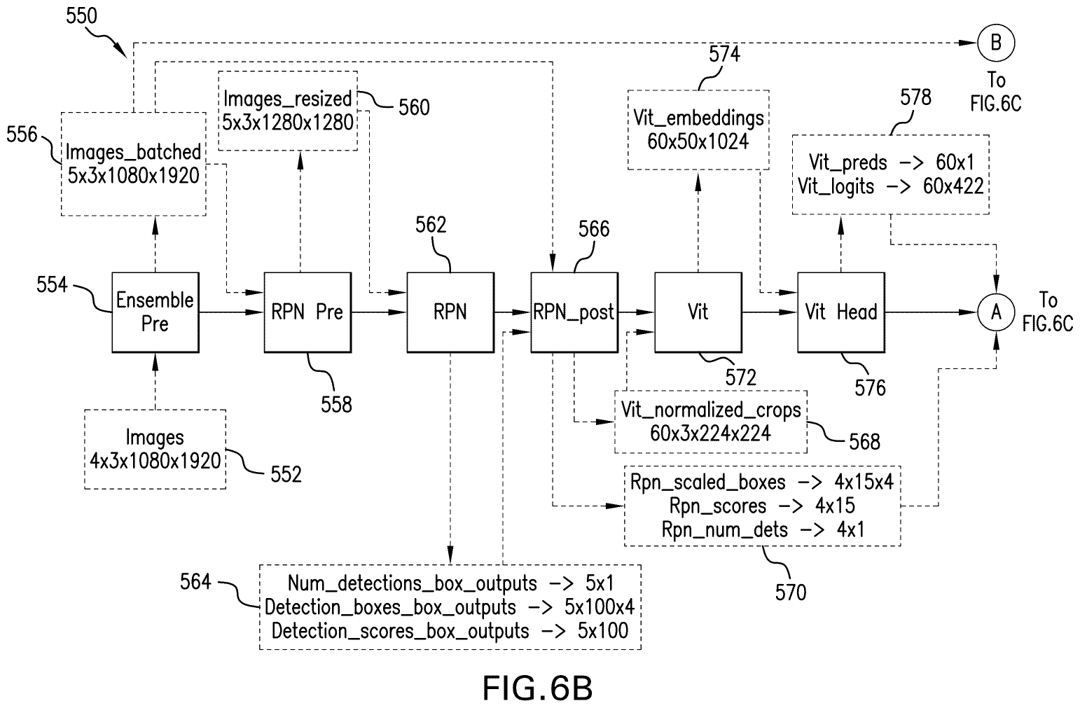

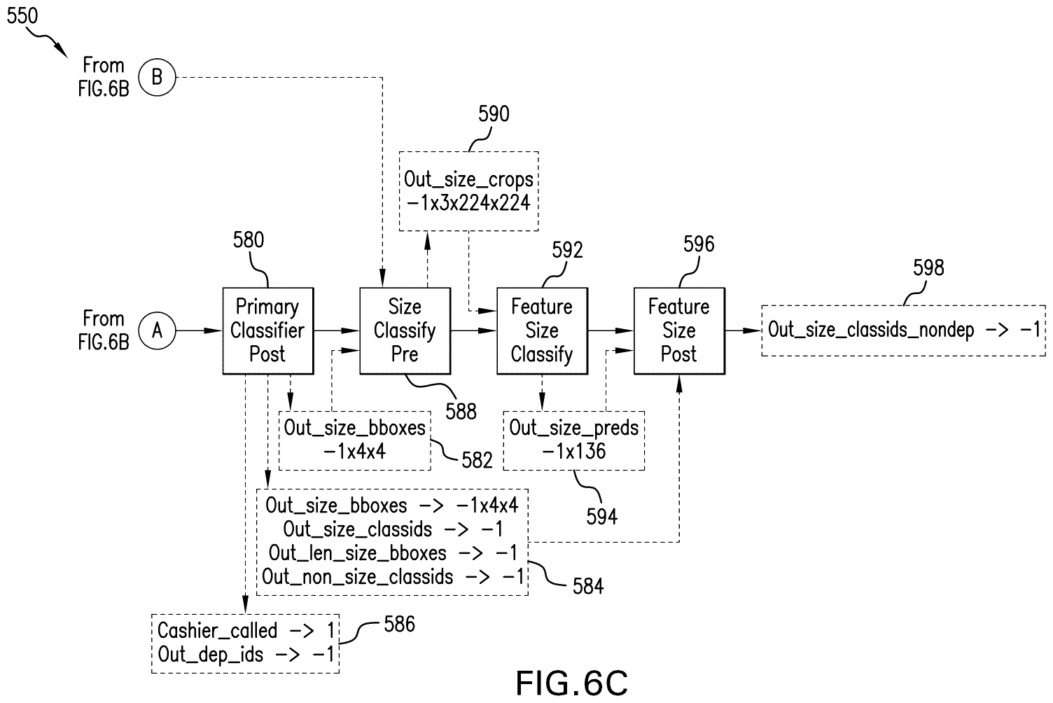

FIG. 6A illustrates an example non-hierarchical detection framework 500 that can be run on an extreme edge computing device, such as extreme edge computing devices 218 or 238 of FIG. 3, to detect items in a scene observed by cameras of an assisted checkout device, such as device 100 of FIG. 2. The cameras of the assisted checkout device observe the scene over the checkout plane from different angles and thus may observe items (including, e.g., identifiable store inventory items available for purchase, non-purchasable items, and unidentified items) placed in the scene. The scene, and the items in the scene, appear in images 502 derived from video streams provided by the cameras. In the illustrated example, there may be four such images 502 provided to a detector/classifier ML model 504 for inferencing. The four images 502 are each of a different angle of the scene, such that they each provide different information about the scene.

In the illustrated example of FIG. 6A, detector/classifier 504 can also be provided with other data that can be used for detection 506. The detector/classifier 504 can draw anchor boxes around detected objects and determine or predict the type of object in each anchor box. For example, the detector/classifier 504 may determine or predict from the image data that an item within an anchor box is a bottle of a certain brand of soft drink, or a bottle of a different brand of soft drink, or a candy bar of a first brand, or a candy bar of a second brand, etc.

The detector/classifier 504 may be a scale-free ML model and may have difficulty, therefore, determining or predicting the size of the determined or predicted item. For example, the detector/classifier 504 by itself may have unacceptably low accuracy in predicting whether an item is a 1-liter bottle of a brand of soft drink, as opposed to a 16 oz. bottle of the brand of soft drink or a 2-liter bottle of the particular brand of soft drink. Accordingly, the detection framework 500 can use a combination of ML models to improve item size determining or prediction. A detector/classifier post-processor 508, which may be run, for example, using Python, can output anchor boxes indicating the locations of detected objects in all four provided cameras views. Outputs 510 of the detector/classifier post-processor 508 can be provided to a size classifier pre-processor 512, which can be an ML model. Outputs 514 of the size classifier pre-processor 512 can be provided to a size classifier 516, which can likewise be an ML model. The size classifier 516 associates anchor boxes from the corresponding views to determine a location where an item is in present in each of the four camera views, then determines or predicts the size of the object, resulting in size prediction data 518. The size classifier 516 can, for example, be trained beforehand on training data that includes information about the finite number of predefined sizes for items of various types.

A hierarchical approach functions differently than the example approach 500 illustrated in FIG. 6A. Instead of using a direct-detection model with a classifier model, given a scene with items, a first ML model, e.g., a region proposal network (RPN) ML model, may be employed to only predict anchor boxes surrounding items in the scene. This first ML model does not attempt to detect or predict the identity of the items in the scene. Cropped images of the contents of the anchor boxes are then provided to a secondary image classifier, e.g., a vision transformer (ViT), which can then determine or predict whether the bounded item is an unknown item or a known item, and if it is a known item, the identity of the item.

Using a hierarchy of ML models for item recognition can improve scalability of the assisted checkout system as the number of items increases. For example, in a first ML stage, a first ML model can determine whether an item is a can, a bottle, or a bag. In a second ML stage, a second ML model can determine which brand the item belongs to, within the determined first-stage class of can, bottle, or bag items. In a third stage, a third ML model third stage can determine the size of the item. By splitting the item recognition process into phases, the scalability of the assisted checkout system increases as items are added to the system. Non-hierarchical approaches can require ML models representing a large fraction of the recognition system to be trained from scratch every time additional items are added. By contrast, with hierarchical approaches, only one or more models in a certain branch of the hierarchy may need to be retrained, which models can represent a comparatively smaller fraction of the overall recognition system. Usage of a hierarchical ML approach thus reduces the training computational overhead and training time when items are added to or removed from the system.

The hierarchical approach can leverage the observation that most retail items have their packaging from the same suppliers and look exactly the same. E.g., most soft drink cans have the same form factor, despite being of different brands. Thus, for example, an ML model can be designed to recognize a particular form factor of can, irrespective of brand, as a class of item, which form factor can itself be indicative of item size. Hierarchical approaches can thus increase our accuracy and also allow the addition of new items in a logical way.

More specifically, FIGS. 6B-6C illustrate an example hierarchical detection framework 550 that can be run on an extreme edge computing device, such as extreme edge computing devices 218 or 238 of FIG. 3, to detect items in a scene observed by cameras of an assisted checkout device, such as device 100 of FIG. 2. The cameras of the assisted checkout device observe the scene over the checkout plane from different angles and thus may observe items (including, e.g., identifiable store inventory items available for purchase, non-purchasable items, and unidentified items) placed in the scene. The scene, and the items in the scene, appear in images 552 derived from video streams provided by the cameras. In the illustrated example, there may be four such images 552 (e.g., high definition images) captured by four respective cameras that are provided (e.g., streamed) to an ensemble preprocess module/subsystem 554, which has output data 556 of image batch data including five images. Accordingly, in embodiments in which the images 552 include only four images, the preprocess module/subsystem 554 may add a fifth blank image to the batch (e.g., an image with all zeros). In other examples, not illustrated, the hierarchical detection framework 550 may utilize greater or fewer than four cameras. For example, a fifth camera (e.g., an IP-based camera) and its captured images may also be used within the framework 550 (e.g., in which case a blank image may not be added). In some embodiments, the ensemble preprocess module/subsystem 554 may also account for cameras (and therefore image streams) that are inoperable at the current time (e.g., by providing blank images in the absence of real-time image data).

The data 556 including the batched images are provided to the RPN preprocess module/subsystem 558, which resizes the images and provides as output data 560 the resized images. In the illustrated example, the images are resized to be 1280×1280 pixels. The resized images (i.e., the data 560) are provided to the RPN module/subsystem 562 (i.e., the region proposer module), which determines/provides regions of the countertop/checkout plane (e.g., regions of the base 610, 710). The RPN module/subsystem 562 generates data 564 indicative of the number of detections per camera view (num_detections_box_outputs), bounding boxes for each camera view (detection_boxes_box_outputs), and detection scores for each bounding box (detection_scores_box_outputs). The RPN post-process module/subsystem 566 receives the data 564 and also the batched image data 556, and generates normalized crop data 568. Additionally, if a fifth blank image was added to the batched image data 556 by the ensemble preprocess module/subsystem 554, the RPN post-process module 566 may remove the blank image. In the illustrated example, there is a maximum of 15 crops per view, which results in 60 crops in total of a particular size (e.g., 224×224 pixels), and there are a total of three color channels in the images (e.g., RGB). The RPN post-process module/subsystem 566 also generates as data 570 RPN scaled boxes (e.g., to match the original HD image size), the RPN scores, and the RPN number of detections. By adding blank images in place of video images for cameras that are not connected or are inoperative, and subsequently removing the blank images at the RPN post-process module 566, the assisted checkout system can continue to function, despite one or more of the cameras being disconnected or inoperable for a period of time.

The normalized crops data 568 is posted into the vision transformer (VIT) module/subsystem 572, which is trained on the set of objects to be recognized. Accordingly, the VIT module/subsystem 572 outputs VIT embeddings data 574 (e.g., a vector of size 60×50×1024 in the illustrative embodiment), which is provided to the VIT head module/subsystem 576. The VIT head module/subsystem 576 generates data 578 that includes a set of VIT predictions and logits. Each of the VIT predictions is a respective classification for a particular crop of the 60 crops included in the data. The VIT logits are the output of the last layer for each of the 60 crops in the data. In the illustrative embodiment, the system uses 422 classes for training; however, a different number of classes may be used in other embodiments. The VIT logits data is indicative of the probability that the object being classified is the respective class. In other word, the VIT head module/subsystem 576 generates data 578 that includes both probabilities and predictions. The system may calculate entropy using the VIT logit data. When an object detector/classifier is trained on known objects very well, the entropy is typically very low, which is indicative of low uncertainty. However, when an object detector/classifier analyzes an unknown object, the entropy is typically very high, which is indicative of high uncertainty and may be used for classification of an unknown object.

The primary classifier post-process module/subsystem 580 receives the data 570, 576, 578 and may handle the thresholding described above associated with classification of unknown objects. The primary classifier post-process module/subsystem 580 also removes bounding boxes that are detected outside the countertop/checkout plane to ensure that only boxes on the countertop/checkout plane are being analyzed. The primary classifier post-process module/subsystem 580 also utilizes a voting algorithm across all of the camera views to generate a final prediction. Further, such analysis is performed on a depreciated set (e.g., a set with size classes depreciated). For example, at this stage, the system may not distinguish between two different sizes of the same object (e.g., 500 mL vs. 750 mL), it will just identify that the object is the particular object of some (undetermined) size.

Based on the final list of the predictions after voting, the size classes may be accumulated into a vector and the non-size classes may be accumulated into another vector. The non-size classes may be output as data 582, which are bounding boxes for the non-size classes, and provided to a size classify preprocess module/subsystem 588. Additionally, data 584 may be output indicative of bounding boxes for the size classes, class identifiers for the size classes, the length of the bounding boxes, and class identifiers for the non-size classes. The primary classifier post-process module subsystem 580 may also output data 586 that includes a casher called flag (e.g., if there is a certain uncertainty of the prediction, the cashier may be flagged to be called).

The size classify preprocess module/subsystem 588 crops the parts of the image that have size objects to generate size crop data 590. There may also be an association algorithm that associates bounding boxes across all camera views. For example, if a particular drink object is on the countertop/checkout plane, then the drink object should cause the creation of a bounding box in each view. Accordingly, the bounding boxes for the same drink objects across all of the views are associated with one another (e.g., such that the particular drink object now has four crops associated with it). The feature size classify module/subsystem 592 is a size classifier that receives that data 590, processes the associated bounded boxes of the depreciated class identifiers, and outputs data 594 indicative of the size of the object. For example, if the system includes a COCA-COLA class, then all of the crops associated with that class are provided to the feature size classify module/subsystem 592, which outputs the determined size of the COCA-COLA (e.g., small, medium, large, ½ L, 1 L, etc.). The feature size post-process module/subsystem 596 combines the probabilities of all of the predictions from the size classifier (e.g., from the feature size classify module/subsystem 592) to generate data 598 indicative of a single consensus on the size.

### CONCLUSION

It is to be appreciated that the Detailed Description section, and not the Abstract section, is intended to be used to interpret the claims. The Abstract section may set forth one or more, but not all exemplary embodiments, of the present disclosure, and thus, is not intended to limit the present disclosure and the appended claims in any way.

The present disclosure has been described above with the aid of functional building blocks illustrating the implementation of specified functions and relationships thereof. The boundaries of these functional building blocks have been arbitrarily defined herein for the convenience of the description. Alternate boundaries may be defined so long as the specified functions and relationships thereof are appropriately performed.

It will be apparent to those skilled in the relevant art(s) the various changes in form and detail can be made without departing from the spirt and scope of the present disclosure. Thus the present disclosure should not be limited by any of the above-described exemplary embodiments, but should be defined only in accordance with the following claims and their equivalents.

What is claimed is:

1. A system for automatically identifying a plurality of items positioned at a point of sale (POS) system based on a plurality of item parameters associated with each item as provided by a plurality of images captured by a plurality of cameras positioned at the POS system, comprising:
at least one processor;
a memory coupled with the at least one processor, the memory including instructions that, when executed by the at least one processor cause the at least one processor to:
extract the plurality of item parameters associated with each item positioned at the POS system from the plurality of images captured of each item by the plurality of cameras positioned at the POS system, wherein the item parameters associated with each item when combined are indicative as to an identification of each corresponding item thereby enabling the identification of each corresponding item,
analyze the item parameters associated with each item positioned at the POS system to determine whether the item parameters associated with each item when combined matches a corresponding combination of the item parameters stored in an item parameter identification database, wherein the item parameter identification database stores different combinations of item parameters with each different combination of item parameters associated with a corresponding item thereby identifying each corresponding item based on each different combination of item parameters associated with each corresponding item,
identify each corresponding item positioned at the POS system when the item parameters associated with each item when combined match a corresponding combination of item parameters as stored in the item parameter identification database and fail to identify each corresponding item when the item parameters associated with each item when combined fail to match a corresponding combination of item parameters, and
stream the item parameters associated with each item positioned at the POS system that fail to match to the item parameter identification database thereby enabling the identification of each failed item when the combination of item parameters of each failed item are subsequently identified when subsequently positioned at the POS system after the failed match.

2. The system of claim 2, wherein the processor is further configured to:
automatically extract the item parameters associated with each item positioned at the POS system from the images captured of each item that failed to be identified as POS data, wherein the POS data depicts the item parameters captured at the POS system and identified as failing to match a corresponding combination of item parameters stored in the item parameter identification database; and
automatically stream the POS data and each corresponding image captured of each item positioned at the POS system that failed to match a corresponding combination of item parameters stored in the item parameter identification database to an item identification server.

3. The system of claim 2, wherein the processor is further configured to:
automatically receive updated streamed POS data associated with each image captured of each item that failed to be identified as trained on a neural network based on machine learning as the neural network continuously updates the streamed POS data based on past POS data as captured from past images captured of each item previously positioned at the POS system that failed be identified as streamed from the item identification server;
analyze the updated streamed POS data as provided by the neural network to determine a plurality of identified item parameters associated with each item currently positioned at the POS system that failed to be identified when previously positioned at the POS system, wherein the identified item parameters associated with each are indicative to an identity of each item currently positioned at the POS system when each item when previously positioned at the POS system failed to match a corresponding combination of item parameters as stored in the item parameter identification database; and
automatically identify each corresponding item currently positioned at the POS system when the identified item parameters associated with each item as provided by the neural network when combined match the corresponding combination of item parameters associated with each item as stored in the item parameter identification database.

4. The system of claim 3, wherein the processor is further configured to:
continuously stream POS data as automatically extracted from the item parameters associated with each item positioned at a plurality of POS systems from the corresponding plurality of images captured of each item positioned at each corresponding POS system that fails to be identified to the item identification server for the neural network to incorporate into the determination of identified item parameters for each of the items positioned at each corresponding POS system.

5. The system of claim 4, wherein the processor is further configured to:
automatically receive updated streamed POS data associated with each image captured of each item previously positioned at each corresponding POS system as trained on by the neural network based on machine learning as the neural network continuously updates the streamed POS data based on the past POS data as captured from past images captured of each item previously positioned at each of the POS systems, wherein the neural network is trained on with an increase in the POS data associated with each item that fails be identified to match due to an increase the POS systems that each item is positioned and fails to identify each item;
analyze the updated streamed POS data as provided by the neural network based on the POS data provided by each of the POS systems to determine the plurality of identified item parameters associated with each item currently positioned at each POS system that failed to be identified when previously positioned at each POS system; and
automatically identify each corresponding item currently positioned at each POS system when the identified item parameters associated with each item as provided by the neural network when combined match the corresponding combination of item parameters associated with each item as stored in the item parameter identification database, wherein each corresponding item is automatically identified in a decreased duration of time due to the increase in the POS data associated with each item based on the increase in the POS systems that each item previously failed to be identified.

6. The system of claim 3, wherein the processor is further configured to:
automatically map the images captured of each item positioned at the POS system that failed to be identified to a corresponding POS record, wherein the POS record is generated by the POS system for each item that is positioned at the POS system;
automatically extract the POS data as generated from the item parameters extracted from each of the images captured of each item positioned at the POS system from the images captured of each item that failed to be identified; and
automatically generate a data set for each item that failed to be identified that matches each corresponding POS record to the corresponding images captured of each item when positioned at the POS system thereby generating the corresponding POS record, wherein the POS data extracted from each of the images captured of each item that failed to be identified is incorporated into the data set of each item that failed to be identified based on the mapping of the images of each item that failed to be identified to the corresponding POS record.

7. The system of claim 6, wherein the processor is further configured to:
automatically stream the POS data and each corresponding image captured of each item positioned at the POS system that failed to be identified to the item identification server as included in each data set associated with each item that failed to be identified to be trained on the neural network based on machine learning as the neural network continuously updates the streamed POS data as included in each data set based on past POS data included in the data set as captured from past images captured of each item previously positioned at the POS system that failed to be identified.

8. The system of claim 7, wherein the processor is further configured to:
identify a first item when the POS data associated with the first item as generated from the item parameters extracted from each of the images captured by the cameras positioned at the POS system match POS data as included in a corresponding first data set thereby identifying the first item and fail to identify a second item when POS data associated with the second item as generated from the item parameters extracted from each of the images captured by the cameras positioned at the POS system fail to match POS data as included in a data set thereby failing to identify the second item;
automatically map the POS data of the second item and the images captured of the second item to a second POS record generated by the POS system for the second item as positioned at the POS system to generate a second data set for the second item;
automatically stream the POS data of the second item and the images captured of the second item as mapped to the second POS record of the second item as included in the second data set to the item identification server to be trained on the neural network based on machine learning as the neural network continuously updates the streamed POS data as included in the second data set each time the second item is positioned at the POS system and images are captured of the second item; and
automatically identify the second item when the POS data associated with the second item as generated from the item parameters as extracted from each of the images captured by the cameras positioned at the POS system match the POS data included in the second data set as trained on by the neural network thereby identifying the second item.

9. The system of claim 6, wherein the processor is further configured to:
automatically extract a plurality of features associated with each item positioned at the POS system from the images captured of each item that failed to be identified;
automatically map the features associated with each item positioned at the POS system that failed to be identified to a corresponding POS record; and
automatically generate a corresponding feature vector that includes the features associated with each corresponding item positioned POS system that failed to be identified to map each corresponding feature vector to each corresponding data set for each item that failed to be identified based on the POS record for each item that failed to be identified.

10. The system of claim 9, wherein the processor is further configured to:
automatically stream each corresponding feature vector and each corresponding image captured of each item positioned at the POS system that failed to be identified to the item identification server as included in each data set associated with each item that failed to be identified to be trained on the neural network based on machine learning updates the streamed feature vectors as included in each data set to associate the features of each corresponding item to identify each item that failed to be identified based on the features included in each corresponding feature vector for each item.

11. A method for automatically identifying a plurality of items positioned at a Point of Sale (POS) system based on a plurality of item parameters associated with each item as provided by a plurality of images captured by a plurality of cameras positioned at the POS system, comprising:
extracting the plurality of item parameters associated with each item positioned at the POS system from the plurality of images captured of each item by the plurality of cameras positioned at the POS system, wherein the item parameters associated with each item when combined are indicative as to an identification of each corresponding item thereby enabling the identification of each corresponding item;
analyzing the item parameters associated with each item positioned at the POS system to determine whether the item parameters associated with each item when combined matches a corresponding combination of the item parameters stored in an item parameter identification database, wherein the item parameter identification database stores different combinations of item parameters with each different combination of item parameters associated with a corresponding item thereby identifying each corresponding item based on each different combination of item parameters associated with each corresponding item;
identifying each corresponding item positioned at the POS system when the item parameters associated with each item when combined match a corresponding combination of item parameters as stored in the item parameter identification database and fail to identify each corresponding item when the item parameters associated with each item when combined fail to match a corresponding combination of item parameters; and
streaming the item parameters associated with each item positioned at the POS system that fail to match to the item parameter identification database thereby enabling the identification of each failed item when the combination of item parameters of each failed item are subsequently identified when subsequently positioned at the POS system after the failed match.

12. The method of claim 11, further comprising:
automatically extracting the item parameters associated with each item positioned at the POS system from the images captured of each item that failed to be identified as POS data, wherein the POS data depicts the item parameters captured at the POS system and identified as failing to match a corresponding combination of item parameters stored in the item parameter identification database; and
automatically streaming the POS data and each corresponding image captured of each item positioned at the POS system that failed to match a corresponding combination of item parameters stored in the item parameter identification database to an item identification server.

13. The method of claim 12, further comprising:
automatically receiving updated streamed POS data associated with each image captured of each item that failed to be identified as trained on a neural network based on machine learning as the neural network continuously updates the streamed POS data based on past POS data as captured from past images captured of each item previously positioned at the POS system that failed to be identified as streamed from the item identification server;
analyzing the updated streamed POS data as provided by the neural network to determine a plurality of identified item parameters associated with each item currently positioned at the POS system that failed to be identified when previously positioned at the POS system, wherein the identified item parameters associated with each are indicative to an identify of each item currently positioned at the POS system when each item when previously positioned at the POS system failed to match a corresponding combination of item parameters as stored in the item parameter identification database; and
automatically identifying each corresponding item currently positioned at the POS system when the identified item parameters associated with each item as provided by the neural network when combined match the corresponding combination of item parameters associated with each item as stored in the item parameter identification database.

14. The method of claim 13, further comprising:
continuously streaming POS data as automatically extracted from the item parameters associated with each item positioned at a plurality of POS systems from the corresponding plurality of images captured of each item positioned at each corresponding POS system that fails to be identified to the item identification server for the neural network to incorporate into the determination of identified item parameters for each of the items positioned at each corresponding POS system.

15. The method of claim 14, further comprising:
automatically receiving updated streamed POS data associated with each image captured of each item previously positioned at each corresponding POS system as trained on by the neural network based on machine learning as the neural network continuously updates the streamed POS data based on the past POS data as captured from past images captured of each item previously positioned at each of the POS systems, wherein the neural network is trained on with an increase in the POS data associated with each item that fails to be identified to match due to an increase in the POS systems that each item is positioned and fails to identify each item;
analyzing the updated streamed POS data as provided by the neural network based on the POS data provided by each of the POS systems to determine the plurality of identified item parameters associated with each item currently positioned at each POS system that failed to be identified when previously positioned at each POS system; and
automatically identifying each corresponding item currently positioned at each POS system when the identified item parameters associated with each item as provided by the neural network when combined match the corresponding combination of item parameters associated with each item as stored in the item parameter identification database, wherein each corresponding item is automatically identified in a decreased duration of time due to the increase in the POS data associated with each item based on the increase in the POS systems that each item previously failed to be identified.

16. The method of claim 13, further comprising:
automatically mapping the images captured of each item positioned at the POS system that failed to be identified to a corresponding POS record, wherein the POS record is generated by the POS system for each item that is positioned at the POS system;
automatically extracting the POS data as generated from the item parameters extracted from each of the images captured of each item positioned at the POS system from the images captured of each item that failed to be identified; and
automatically generating a data set for each item that failed to be identified that matches each corresponding POS record to the corresponding images captured of each item when positioned at the POS system thereby generating the corresponding POS record, wherein the POS data extracted from each of the images captured of each item that failed to be identified is incorporated into the data set of each that failed to be identified based on the mapping of the images of each item that failed to be identified to the corresponding POS record.

17. The method of claim 16, further comprising:
automatically streaming the POS data and each corresponding image captured of each item positioned at the POS system that failed to be identified to the item identification server as included in each data set associated with each item that failed to be identified to be trained on the neural network based on machine learning as the neural network continuously updates the streamed POS data as included in each data set based on past POS data included in the data set as captured from past images captured of each item previously positioned at the POS system that failed to be identified.

18. The method of claim 17, further comprising:
identifying a first item when the POS data associated with the first item as generated from the item parameters extracted from each of the images captured by the cameras positioned at the POS system match POS data as included in a corresponding first data set thereby identifying the first item and fail to identify a second item when POS data associated with the second item as generated from the item parameters extracted from each of the images captured by the cameras positioned at the POS system fail to match POS data as included in a data set thereby failing to identify the second item;
automatically mapping the POS data of the second item and the images captured of the second item to a second POS record generated by the POS system for the second item as positioned at the POS system to generate a second data set for the second item;
automatically streaming the POS data of the second item and the images captured of the second item as mapped to the second POS record of the second item as included in the second data set to the item identification server to be trained on the neural network based on machine learning as the neural network continuously updates the streamed POS data as included in the second data set each time the second item is positioned at the POS system and images are captured of the second item; and
automatically identifying the second item when the POS data associated with the second item as generated from the item parameters as extracted from each of the images captured by the cameras positioned at the POS system match the POS data include in the second data set as trained on by the neural network thereby identifying the second item.

19. The method of claim 16, further comprising:
automatically extracting a plurality of features associated with each item positioned at the POS system from the images captured of each item that failed to be identified;
automatically mapping the features associated with each item positioned at the POS system that failed to be identified to a corresponding POS record; and
automatically generating a corresponding feature vector that includes the features associated with each corresponding item positioned at the POS system that failed to be identified to map each corresponding feature vector to each corresponding data asset for each item that failed to be identified based on the POS record for each item that failed to be identified.

20. The method of claim 19, further comprising:
automatically streaming each corresponding feature vector and each corresponding image captured of each item positioned at the POS system that failed to be identified to the item identification server as included in each data set associated with each item that failed to be identified to be trained on the neural network based on machine learning updates the streamed feature vectors as included in each data set to associate the features of each corresponding item to identify each item that failed to be identified based on the features included in each corresponding feature vector for each item.
